(19) United States
(12) Patent Application Publication
(10) Pub. No.: US 2007/0098469 A1
(43) Pub. Date: May 3, 2007

(54) Fixing apparatus for nonheat fixing system, and image forming apparatus having fixing apparatus

(76) Inventors: Mie Yoshino, Kawasaki-shi (JP); Tsuneo Kurotori, Tokyo (JP); Noriyasu Takeuchi, Kawasaki-shi (JP); Eishu Ohdake, Tokyo (JP); Yuichi Aoyama, Yokohama-shi (JP); Yasuo Katano, Yokohama-shi (JP)

Correspondence Address: COOPER & DUNHAM, LLP, 1185 AVENUE OF THE AMERICAS, NEW YORK, NY, 10036, US

(21) Appl. No.: 11/589,127

(22) Filed: Oct. 27, 2006

(30) Foreign Application Priority Data
Oct. 27, 2005 (JP) 2005-313313
Nov. 7, 2005 (JP) 2005-322553
Nov. 16, 2005 (JP) 2005-331947

(51) Int. Cl. G03G 15/20

(52) U.S. Cl. 399/340

(57) ABSTRACT

A fixing apparatus causes a softener to adhere to a toner image and then fixes the toner image onto a recording body. The toner image is formed using a liquid developer comprising a toner and carrier solution. The fixing apparatus comprises a fixing roller as a softener feeding device for feeding a fixer containing a softener to a transfer paper which is a recording body, and a pressurizing roller as a pressurizing device for pressurizing the transfer paper at a fixing nip which is a softener feeding position to which the fixer is fed. As the softener contained in the fixer, the one having an affinity for the carrier solution is used.

### BACKGROUND OF THE INVENTION

1. Field of the Invention

The present invention relates to an image forming apparatus of an electrophotographic system such as a copying machine, facsimile device, printer and the like, and to a fixing apparatus used in such image forming apparatus. Particularly, the present invention relates to a fixing apparatus of a solvent fixing system or chemical fixing system, which applies, to a toner, a fixer containing a solvent for softening, dissolving, or swelling resin particles that form a toner, and then dries the fixer after softening, dissolving, or swelling the fixer, thereby fixing the toner onto a recording medium, and relates also to an image forming apparatus equipped with this fixing apparatus.

2. Description of the Background Art

This type of image forming apparatus is for recording an image having a character, symbol or the like on a recording medium such as a piece of paper, cloth, or OHP sheet on the basis of image information. As such an image forming apparatus, image forming apparatuses of various types are known. Out of these image forming apparatuses, an image forming apparatus of electrophotographic system has been widely used in offices because it is capable of recording a high-resolution image on a piece of plain paper at high speed. In the image forming apparatuses of electrophotographic system, it is mainstream to adopt a heat fixing system for heating and dissolving a toner formed on a recording medium, and then pressurizing the dissolved toner, thereby fixing the toner forming image information onto a recording medium.

However, in such an image forming apparatus, approximately half or more of the electricity is consumed for heating a toner in the fixing apparatus of the heat fixing system, thus fixing apparatuses which are operated under low power consumption (energy conservation) are desired from the aspect of reduction of environmental burdens. Specifically, a fixing system which enormously reduces the heating temperature for the fixing process more than ever or which does not require the heating process is desired. At least from the aspect of energy conservation, the ideal is a nonheat fixing system which fixes a toner onto a recording medium without heating the toner at all.

As such a nonheat fixing system, there is known a so-called solvent fixing system or chemical fixing system, which applies, to a toner, a fixer containing a solvent for softening, dissolving, or swelling resin particles that form a toner, and then dries the fixer after softening, dissolving, or swelling the fixer, thereby fixing the toner onto a recording medium. Since such a system does not require the heating process which involves significant electric power consumption as with the heat fixing system, thus this system can be said to be excellent in terms of an energy-saving strategy. Moreover, in this system a warm-up period is not required while it is required in the heat fixing system, thus a quick start can be performed.

As an image forming apparatus adopting such chemical fixing system, there are known image forming apparatuses equipped with a fixing apparatus of a wet fixing system disclosed in Japanese Patent Application Laid-Open No. 2004-294847 (Prior Art 1), Japanese Patent Application Laid-Open No. 2004-109749 (Prior Art 2), Japanese Patent Application Laid-Open No. 2004-109750 (Prior Art 3), Japanese Patent Application Laid-Open No. 2004-109747 (Prior Art 4), and Japanese Patent No. 3290513 (Prior Art 5). In these image forming apparatuses, a fixer containing a softener is used for wet-fixing a toner.

The abovementioned Prior Art 3 discloses a fixing apparatus which applies a fixer containing a softener to a toner image formed on a photoconductor functioning as an image supporting body. The abovementioned Prior Art 4 discloses a fixing apparatus which applies a fixer containing a softener to a toner image formed on an intermediate transfer body functioning as an image supporting body. However, in these fixing apparatuses, if the fixer containing a softener remains on an image supporting body obtained after a toner is transferred, the softener may be mixed into the toner before an image is formed. It should be noted that the abovementioned Prior Art 5 discloses a fixing apparatus which uses fixer feeding means to feed a fixer to a toner image obtained after a toner is transferred to a recording medium. In this fixing apparatus, the softener is not mixed into the toner before an image is formed. However, there arises a problem in which the toner on the recording medium is transferred to a roller holding the fixer (offset). The occurrence of offset deteriorates the quality of an image, and Prior Art 5 does not take effective measures against this problem.

For this reason, for example, Japanese Published Examined Application No. S49-026591 (Prior Art 6) discloses a technology of preventing the occurrence of offset on the roller side by pressing a toner against a transfer paper by means of a corona discharge, when applying fixing solvent. The above application describes an embodiment in which corona discharge is performed by a charger, but the configuration of this technology is complex because it is practically difficult to convey a transfer paper between the roller and the charger and thus a conveying belt or other conveying aid is required. Moreover, the above application suggests application of a bias between rollers. But in this case if the rollers are not separated from each other when there is no transfer paper therebetween, a liquid pool is formed between the rollers, wetting an edge of the transfer paper. However, separation of the rollers and the paper not only creates a complex apparatus but also is almost impossible to be performed in an apparatus which performs output at high speeds. Although the idea of preventing the occurrence of offset by means of an electric field is described, various problems still exist in actually performing the fixing in Prior Art 6.

Furthermore, the abovementioned Prior Art 3 discloses a technology in which a solution, which is harmless to humans, is used as a fixer, and the fixer is fed to a toner before transferring the toner to a transfer paper or other recording medium, so that the amount of fixer on the recording medium is less and that a curl or wrinkle is not formed thereon, whereby the amount of fixer on a non-image section is reduced. However, in the method of feeding a fixer to a toner before transferring the toner to a recording medium, the fixer needs to be prevented from being mixed into the toner before image formation, thus there is a problem that the handling of the liquid is difficult.

As described above, in the conventional fixing method using a softener for softening resin particles, because of toner particles, fine asperities are formed on the surface of a toner image on a recording medium, the toner image being softened by the fed fixer. If the toner image is hardened, a fixed image which is obtained after fixing the toner will also have fine asperities. There occurs a phenomenon in which when rubbing the fixed image, the asperities are scratched and a part of the image is smeared, distorting the image (smear).

With the recent request for high-speed image formation, not only a quick start but also increased speed for fixing an image is desired. However, a toner image and the toner of the toner image formed using a liquid developer composed of a carrier solution are coated with the carrier solution, thus if it is difficult for the softener to be immersed into the carrier solution, it takes a long period of time for the softener to reach the toner. Therefore, the problem is that the fixing speed cannot be increased.

On the other hand, Japanese Patent Application Laid-Open No. 53-118139 (Prior Art 7) discloses a solvent fixing system as a nonheat fixing system in which a solvent for dissolving resin particles forming a toner is applied to an unfixed toner. In this Prior Art 7, water, which is a dispersing medium for a softener, does not fall under the category of VOC (volatile organic compounds) and thus has no problem. However, regarding other organic compounds in the softener, there is described the use of the materials that are considered as problems in terms of the odor (unpleasant odor or irritating odor) and safety (substances corresponding to PRTR Law or substances corresponding to Proposition 65). When using these materials in an office environment, members or unpleasant odor having a harmful effect on the human body permeate the office, thus it is a problem to use these materials in an office environment. Moreover, when a large quantity of the fixer is applied to an unfixed toner image, wrinkles or curls are formed on a recording medium because the moisture is absorbed, whereby safe and high-speed conveyance of the recording medium (transfer paper), which is required in an image forming apparatus, is significantly impaired. Furthermore, when attempting to evaporate and eliminate this large quantity of water by using a drier, the amount of electricity is required as much as required in the abovementioned heat fixing apparatus. In addition, the surface having toner fine particles is subjected to a water-shedding treatment in order to prevent the mobility of the particles from being damaged by the influence of moisture in the air. Therefore, in the case of s fixer having water as a solvent medium, when the fixer is applied to an unfixed toner image, the toner fine particles are repelled by the liquid, whereby the image is distorted, which is an important problem.

In the solvent fixing system disclosed in Japanese Patent Application Laid-Open No. S59-119364 (Prior Art 8), a toner is dissolved, and a solvent, which is compatible with silicone oil, is mixed into silicone oil, whereby distortion of an image caused by softening the toner is prevented. Specifically, flow of the softened toner is controlled by silicone oil with relatively high viscosity. Further, the solvent which is disclosed in Prior Art 8 is a solvent of the aromatic series such as benzene or a solvent of the ketone series such as methyl ethyl ketone, and has volatility and strong odor, thus it has a lot of problems in terms of the VOC problem.

In Prior Art 1, there is proposed a method of increasing the adherence between toner particles and the adherence between the toner and a recording paper by previously pressurizing/heating toner particles so that the toner does not scatter when applying the fixer, and then deforming the toner. Therefore, since this method is based on pressurization, the heating means is in contact with the toner layer, thus an image may be damaged.

Technologies relating to the present invention are also disclosed in, e.g., Japanese Patent No. 3436810 (Prior Art 9), Japanese Patent Application Laid-Open No. H9-078039 (Prior Art 10), and Japanese Patent Application Laid-Open No. 2004-109751 (Prior Art 11).

### SUMMARY OF THE INVENTION

A first object of the present invention is to provide a fixing apparatus capable of realizing high-speed fixing when feeding a softener to a toner image, which is formed using a liquid developer composed of a toner and carrier solution, and fixing the toner image onto a recording medium, and to provide also an image forming apparatus equipped with this fixing apparatus.

A second object of the present invention is to provide a fixing apparatus capable of maintaining the quality of a fixed image even when feeding the softener to the toner image formed on a recording medium and fixing the toner image onto the recording medium, and to provide also an image forming apparatus equipped with this fixing apparatus.

A third object of the present invention is to provide a fixing apparatus capable of realizing high-speed fixing by performing necessary heating by means of heating means, which is in contact or non-contact with the toner particles or recording medium, and increasing the speed of penetration of a fixer, when fixing the toner image onto the recording medium, and to provide also an image forming apparatus equipped with this fixing apparatus.

In an aspect of the present invention, a fixing apparatus causes a softener having properties of softening resin particles for forming a toner to adhere to the resin particles, and fixes, onto a recording body, a toner image which is formed using a liquid developer comprising the toner and a carrier solution. The softener has an affinity for the carrier solution.

In another aspect of the present invention, a fixing apparatus feeds a softener having properties of softening resin particles for forming a toner to a toner image formed on a recording body, and fixes the toner image onto the recording body. The fixing apparatus comprises a softener feeding device for feeding the softener to the recording body; pressurizing device for pressurizing the recording body at a softener feeding position to which the softener is fed; and an electric field forming device for forming an electric field in a direction of guiding the toner toward the recording body side at the softener feeding position.

In another aspect of the present invention, an image forming apparatus comprises an image forming device for forming an unfixed image by color particles microparticulated through dispersing a color agent and resin; a transfer device for transferring the formed unfixed image onto a recording medium; a feeding device for feeding a fixer, which contains, as a component, a softener having properties of softening the color particles, to the recording medium supporting the unfixed image; a fixing apparatus which fixes the color particles to the recording medium; and at least one temperature adjusting device for performing adjustment to obtain temperature suitable for fixing the color particles.

### BRIEF DESCRIPTION OF THE DRAWINGS

The above and other objects, features and advantages of the present invention will become more apparent from the following detailed description taken with the accompanying drawings in which:

FIG. 1 is a figure showing a schematic configuration of a substantial part of a printer which is an image forming apparatus according to an embodiment 1 of the present invention;

FIG. 2A is a figure showing an external appearance of a feed roller used in the printer;

FIG. 2B is a side view showing a configuration of the feed roller;

FIG. 2C is a figure showing a pyramid-shaped fine groove of the feed roller;

FIG. 2D is a figure showing a lattice-shaped groove of the feed roller;

FIGS. 3A through 3C are figures showing temporal changes of a fixer when the fixer is fed to a toner;

FIG. 4 is a graph showing a result of an experiment 1 in the embodiment 1;

FIG. 5 is a graph showing a result of an experiment 2 in the embodiment 1;

FIG. 6 is a figure showing a schematic configuration of a substantial part of a printer which is an image forming apparatus according to an embodiment 2 of the present invention;

FIG. 7 is a figure showing a schematic configuration of a substantial part of a printer which is an image forming apparatus according to an embodiment 3 of the present invention;

FIG. 8 is a figure showing a schematic configuration of a substantial part of a printer which is an image forming apparatus according to an embodiment 4 of the present invention;

FIG. 9 is a figure showing a schematic configuration of a substantial part of a printer which is an image forming apparatus according to an embodiment 5 of the present invention;

FIG. 10 is a figure showing a configuration of a fixing apparatus applied to the printer;

FIGS. 11A through 11C are figures showing temporal changes of a fixer and toner when the fixer is fed to the toner;

FIG. 12A is a figure showing a state in which the whole fixer passes through a fixing nip;

FIG. 12B is a figure showing a state in which some of the fixer cannot pass through the same nip;

FIG. 13 is a graph showing a result of an experiment for obtaining a constant k;

FIG. 14 is a figure showing an enlarged view of a fixing apparatus of the printer and explaining such fixing apparatus;

FIG. 15 is a cross-sectional view showing a schematic configuration of a fixing roller of the fixing apparatus;

FIG. 16A is a figure showing a method of placing an electrode of a fixing electric field, wherein electricity is applied from a cored bar section by means of an electrode terminal of rotational contact type;

FIG. 16B is a figure showing a method of bringing the electrode into contact with a surface and applying electricity;

FIG. 17 is a table showing the viscosities of the fixer which is actually used in the embodiment 5, upper limits of linear pressure at that moment, and set values of the linear pressure;

FIG. 18 is a figure showing a schematic configuration of a copying machine which is an image forming apparatus according to an embodiment 6 of the present invention;

FIG. 19 is a figure showing a configuration of a substantial part of the copying machine;

FIGS. 20A through 20C are figures showing a process in which toner resin is fixed onto a recording medium;

FIG. 21 is a figure for explaining fixing temperature dependency of the fixing time and smear; and

FIGS. 22 through 27 are figures for explaining modifications of the embodiment 6.

### DESCRIPTION OF THE PREFERRED EMBODIMENTS

Preferred embodiments of the present invention will be described hereinafter. It is to be noted the reference numerals used in each embodiment are independent of the reference numerals of the other embodiments, i.e., the same reference numerals do not always designate the same structural elements.

1^{st} Embodiment

Hereinafter, the embodiment 1 in which the present invention is applied to an electrophotographic image forming apparatus using a liquid developer is explained.

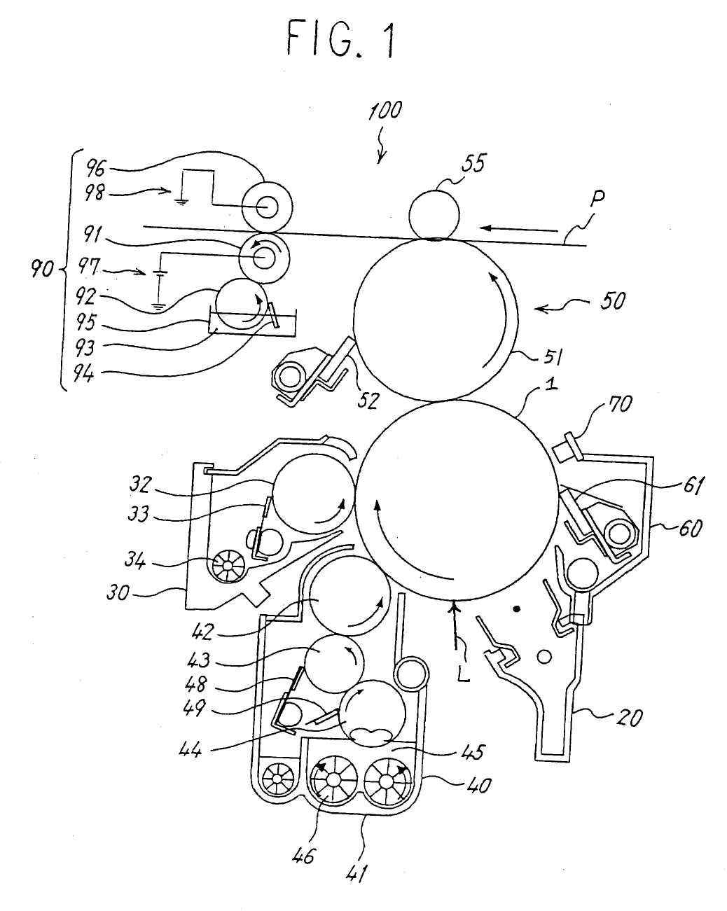

FIG. 1 shows a schematic configuration of a substantial part of a printer 100 which is an image forming apparatus according to the present embodiment 1. In the printer 100, there are disposed around a photoconductor drum 1 functioning as latent image supporting bodies: a charging apparatus 20; an unshown exposure apparatus which irradiates the photoconductor drum 1 with a laser beam L; a development apparatus 40; a transfer apparatus 50; a drum cleaning apparatus 60 and the like. The surface of the photoconductor drum 1 is formed from amorphous silicon (a-Si). As the material of the photoconductor drum 1, OPC or the like can also be used. As the exposure apparatus, an LED, a laser scanning optical system or the like can be used. The transfer apparatus 50 is for transferring a toner image onto a transfer paper P which is a recording body, and a fixing apparatus 90 is provided on the downstream side of a conveying direction in which the transfer paper P is conveyed from the transfer apparatus 50.

It should be noted that by using a photoconductor drum having an amorphous silicon layer as the photoconductor drum 1, a softener does not have to dissolve/swell as in an organic photoconductor (OPC), mechanical strength which is better than that of the organic photoconductor can be exercised, and the life of photoconductor drum can be increased.

Next, an image formation operation of the printer 100 is described.

The photoconductor drum 1 is driven by an unshown driving means such as a motor to rotate in a direction shown by an arrow at a constant speed at the time of copying. Along with this rotary drive, the surface of the photoconductor drum 1 is uniformly charged by corona discharging with the charging apparatus 20. It should be noted that, as the charging apparatus 20, a charging apparatus which realizes charging by means of corona discharge as described above may be used, or a charging apparatus of a type in which a predetermined charging bias is applied by a charging member such as a charging roller contacting with the photoconductor drum 1 may be used.

The surface of the photoconductor drum 1, which is charged uniformly by the charging apparatus 20, is irradiated with the laser beam L by the exposure apparatus on the basis of image information, and supports electrostatic latent images. These electrostatic latent images are developed while passing through a region which faces a developing roller 42 of the development apparatus 40 that uses a liquid developer.

A toner image, which is developed on each of the electrostatic latent images, reaches a position facing the transfer apparatus 50 as the photoconductor drum 1 rotates. The transfer apparatus 50 is pressed by an intermediate transfer roller 51 against the photoconductor drum 1, whereby a primary transfer nip is formed. There is provided an unshown power source or the like for applying the intermediate transfer roller 51 with a transfer bias of a polarity opposite to the charging polarity of the toner, and, at the time of printing, this power source moves the intermediate transfer roller 51 to rotate it in a direction shown by an arrow in the figure. In the primary transfer nip, a transfer electric field is formed by the potential difference between the intermediate transfer roller 51, which is applied with the transfer bias, and the surface of the photoconductor drum 1. A toner image, which enters the primary transfer nip as the photoconductor drum 1 rotates, is subjected to the action of the transfer electric field or nip voltage, and is primarily transferred onto the intermediate transfer roller 51.

The primarily transferred toner image is secondary transferred onto a transfer paper P by a secondary transfer nip or transfer electric field formed by the intermediate transfer roller 51 and a secondary transfer roller 55, the transfer paper P being conveyed by an unshown recording body conveying member. A fixing apparatus 90, the detail of which is described hereinafter, feeds a fixer as a fixing agent containing a softener to the transfer paper P having the transferred toner image thereon, whereby the toner image is fixed onto the transfer paper P. The transfer paper P having the toner image fixed thereon is ejected from the fixing apparatus 90 to the outside of the apparatus through a paper discharge path.

The surface of the photoconductor drum 1 which was passed through the primary transfer nip is subjected to removal of electricity by an electricity-removing lamp 70 to remove residual charge. The surface of the photoconductor drum 1, which was subjected to removal of electricity by the electricity-removing lamp 70, is subjected to scraping removal of residual liquid developer by a cleaning blade 61 of the drum cleaning apparatus 60. Through this scraping removal, the surface of the photoconductor drum 1 is brought to the initial state, so that the subsequent image formation can be realized.

The structure of the development apparatus 40 is described next.

This apparatus comprises a developer storage tank 41, a pair of stirring screws 46, anilox roller 44, developing roller 42, intermediate roller 43, doctor blade 49, developing cleaning blade 48, and the like.

The development apparatus 40 uses a liquid developer 45 in which a toner is dispersed in dimethyl polysiloxane oil having a viscosity of 50 [mPa·s] as a carrier solution, to develop an electrostatic latent image, which is formed on the surface of the photoconductor drum 1, to a toner image. The liquid developer 45 is not the one with low viscosity (approximately 1 [mPa·s] and low density (approximately 1[%]) using Isopar (trademark of Exxon Corporation), which is commercially available and generally used conventionally, as a carrier, but the one with high viscosity and high density.

As the range of the viscosity and the ratio of the solid toner of the developer, for example, a developer having a viscosity of 50 [mPa·s] through 5000 [mPa·s] and a ratio of the solid toner of 5[%] through 40[%] isused. As the carrier solution, the one with high insulating properties such as silicone oil, normal paraffin, Isopar V (trademark of Exxon Corporation), vegetable oil, mineral oil, or the like is used. The volatility or nonvolatility can be selected according to the purpose.

The toner which has a colored particles mainly comprises a styrene acrylic resin, polyester resin, epoxy resin or the like, and a color pigment (disazo-yellow, quinacridone, copper phtalocyanine, carbon black, or the like) as the colored fine particles, and may be mixed with a charge control agent and dispersing agent. The average particle diameter is adjusted to approximately 3 [μm] but can be selected from submicron through 6 [μm] according to the purpose.

The pair of stirring screws 46 are arranged parallel with each other so as to be immersed in the liquid developer 45 in the developer storage tank 41 and, as shown by arrows in the figure, are driven to rotate in the opposite direction to each other by the unshown driving means. When the development apparatus 40 starts the developing operation, these stirring screws 46 rotate in the opposite direction to each other to stir the liquid developer 45 in the developer storage tank 41. By this stirring, the toner density and the viscosity of the liquid developer 45 are made uniform. Further, by the opposite rotation of the stirring screws, the liquid level of the liquid developer is swollen between the stirring screws as shown in the figure, and the liquid adheres to the anilox roller 44 disposed thereabove.

The anilox roller 44 as an application roller is driven by the unshown driving means to rotate in the direction of an arrow in the figure, to thereby draw up the liquid developer 45 adhered thereto as described above. A plurality of concave sections, which are not shown, are formed on the periphery of this anilox roller 44. A part of the liquid developer 45 drawn up by the anilox roller 44 is stored in these concave sections.

The doctor blade 49 as a regulatory blade, which is formed from metal such as stainless steel, abuts against a surface of the anilox roller 44 to thereby scrape off the excess liquid developer 45 adhered onto the anilox roller 44. By this scraping, the amount of the liquid developer 45 on the anilox roller 44 is accurately weighed so as to correspond to the capacity of the plurality of concave sections.

The intermediate roller 43 contacts with the surface of the anilox roller 44 which has passed through the abutment section with the doctor blade 49, and rotates so as to move the surface thereof in the direction same as that of the anilox roller at the contact section. At an application nip which is the contact position between the intermediate roller 43 and the anilox roller 44, the both rollers come into contact with each other while moving the surfaces thereof in the same direction, and the liquid developer 45 on the anilox roller 44 is accurately weighed regardless of the viscosity thereof, whereby a thin layer of the developer having a uniform thickness can be formed on the intermediate roller 43.

It should be noted that the doctor blade 49 may be omitted in the configuration of feeding, to the developing roller 42, the liquid developer 45 which has been drawn up by the anilox roller 44 using the intermediate roller 43. The reason is that the excess liquid developer 45 is regulated by passing through the nip section at which the anilox roller 44 and intermediate roller 43 abut against each other.

The developing roller 42 rotates so as to move the surface thereof in the direction opposite to that of the intermediate roller 43 at the contact section, while contacting with the intermediate roller 43. At the nip which is the contact position between the intermediate roller 43 and the anilox roller 44, the both rollers come into contact with each other while moving the surface thereof in the counter direction to each other, and a thin layer of the developer formed on the intermediate roller 43 is transferred to the developing roller 42.

Moreover, while feeding of the liquid developer to the developing roller 42 is started on the outlet side of the nip, the liquid developer 45, which has shifted to the developing roller 42, moves in the direction opposite to the feed direction. By such application, a thin layer of the developer having a uniform thickness and consisting of the liquid developer 45 is formed on the surface of the developing roller 42.

The developing roller 42 is provided with, on the periphery thereof, a conductive elastic layer formed from a conductive urethane rubber or the like, and comes into contact with the photoconductor drum 1 while rotating at the same speed with the photoconductor drum 1, to form a developing nip. In this developing nip, a developing electric field is formed by a potential difference between the photoconductor drum 1 and the developing roller 42 to which a developing bias of the same polarity as the charging polarity of the toner is applied from an unshown power source. Specifically, at the developing nip, the developing roller 42, the ground section of the photoconductor drum 1, and the electrostatic latent image are respectively charged with the potential of the same polarity as that of the toner, and the value of the potential gradually becomes lower in the order of the ground section, the developing roller 42, and the electrostatic latent image.

Then, the developer thin layer, which is formed on the surface of the developing roller 42, is used for developing a latent image formed on the photoconductor drum 1 by this developing electric field when the developer passes through the developing nip. Therefore, between the ground section and the developing roller 42, there is formed an electric field for electrostatically moving the toner towards the developing roller 42 having a lower potential. Furthermore, between the developing roller 42 and the electrostatic latent image, there is formed an electric field for moving the toner towards the electrostatic latent image having a lower potential. At the developing nip where such developing electric fields are formed, the toner in the thin layer of the developer electrophoretically moves and gathers toward the surface of the developing roller 42 between the developing roller 42 and the ground section, and further electrophoretically moves and adheres toward the electrostatic latent image between the developing roller 42 and the electrostatic latent image. By this adhesion, the electrostatic latent image is developed to thereby form a toner image.

The thin layer of the developer, which remains on the developing roller 42 after the development is finished, is brought to the intermediate roller 43 at the nip section between the developing roller 42 and the intermediate roller 43, is then removed from the surface of the intermediate roller 43 by the developing cleaning blade 48, and is brought back to the inside of the developer storage tank 41 by gravity.

It should be noted that the developing cleaning blade 48 is a metal blade or rubber blade. As the developing cleaning member which removes the developing solution adhered to the surface of the intermediate roller 43, not only a blade-like cleaning blade such as this developing cleaning blade 48 but also a roller may be used.

Next, a photoconductor sweeping apparatus 30 for removing the excess toner adhered to the surface of the photoconductor drum 1 is described.

As shown in FIG. 1, the printer 100 comprises the photoconductor sweeping apparatus 30 on a downstream side in the moving direction on the surface of the photoconductor drum 1 from the development apparatus 40, and on an upstream side in the moving direction on the surface of the photoconductor drum 1 from the transfer apparatus 50. The photoconductor sweeping apparatus 30 comprises a sweep roller 32, sweep cleaning blade 33, carrier recovery apparatus 34, and the like. It should be noted that the sweep cleaning blade 33 is a metal blade or rubber blade. As the sweep cleaning member, not only a blade-like cleaning blade such as this sweep cleaning blade 33, but also a roller may be used. The sweep roller 32 is installed in a manner that it is pressed against the photoconductor drum 1 so as to hold a developed toner image therebetween.

The outer periphery of the sweep roller 32 is provided with an elastic layer having conductivity. As the material of this elastic layer, a urethane rubber can be used. For the hardness of the rubber in this elastic layer, it is desired to use the one having a hardness of 50 degrees or less as measured by JIS-A hardness. The material is not limited to the urethane rubber, and thus can be a conductive material which does not swell or dissolve in a solvent. Also, the configuration is not limited to the one in which the elastic layer is provided on the sweep roller 32, thus a configuration may be formed in which the elastic layer is provided on the photoconductor drum 1 side. Moreover, the photoconductor drum 1 maybe constituted by an endless belt-like member. The sweep roller is configured such that the surface thereof has a smoothness of at least Rz=3 [μm], by using a coating or a tube.

It should be noted that, if the surface of the sweep roller 32 has conductivity and is configured by a material which does not swell or dissolve in a carrier solution/developer, and the carrier solution/developer does not come into contact with an inner layer of the sweep roller 32, then the material of the elastic layer as the inner layer may not have any restriction in the conductivity/swelling and dissolving, and thus only needs to have elasticity. Therefore, if the elastic layer is provided as the inner layer, and this elastic layer does not have conductivity, voltage needs to be applied to a sweeping electric field from the surface of the sweep roller 32, not from an axis of the sweep roller 32.

Also, the configuration is not limited to the one in which the elastic layer is provided on the developing roller 42 or the sweep roller 32, thus a configuration may be formed in which the elastic layer is provided on the photoconductor drum 1 side. Moreover, the photoconductor drum 1 may be constituted by an endless belt-like member. The developing roller 42 and the sweep roller 32 are configured such that the surfaces thereof have a smoothness of at least Rz=5 [μm] by using a coating or a tube.

When the sweep roller 32 is caused to abut against the photoconductor drum 1 with appropriate pressure, the elastic layer of the sweep roller 32 elastically deforms to form a removal nip. By adjusting the abutment pressure, the nip width, which is the size in the moving direction on the surface in the nip section, can be adjusted.

As described above, at the developing nip between the developing roller 42 and the ground section thereon, the toner in the thin layer of the developer electrophoretically moves and gathers toward the surface of the developing roller, thus, in a theoretical sense, the toner does not adhere to the ground section. However, the toner, which is less charged than normal, may electrophoretically move behind other toners and adhere to the ground section to thereby cause a phenomenon called “fogging” (also referred to as “greasing”).

As one of the functions of the photoconductor sweeping apparatus 30, there is a function of removing a fog toner, which causes such fogging, from the photoconductor drum 1. Specifically, the sweep roller 32 comes into contact with the photoconductor drum 1, while rotating at substantially the same speed with the photoconductor drum 1, to form a removal nip. In this removal nip, a removal bias of the same polarity as the charging polarity of the toner is applied from the unshown power source to the sweep roller 32, whereby a sweeping electric field is formed by a potential difference between the photoconductor drum 1 and the sweep roller 32.

The transfer apparatus 50 is described next.

The transfer apparatus 50 mainly comprises an intermediate transfer roller 51 which is an intermediate transfer body onto which a toner image is transferred from the photoconductor drum 1, and a secondary transfer roller 55 which transfers the toner image from the intermediate transfer roller 51 to the transfer paper P. Further, the intermediate transfer roller 51 may comprise an intermediate transfer body sweep roller.

Regarding the intermediate transfer body sweep roller, the rotation direction thereof is controlled so that the intermediate transfer body sweep roller comes into contact with the intermediate transfer body via the developer and moves in the same direction at a position where the surface of the intermediate transfer body sweep roller faces the intermediate transfer roller 51. A bias of the same polarity as that of the toner is applied to the intermediate transfer body sweep roller, and when the intermediate transfer body sweep roller comes into contact with a developer layer, the carrier solution adheres to the intermediate transfer body sweep roller, but the toner is caused not to adhere to same (for example, −300 [V] is applied to the intermediate transfer body, and 100 [V] is applied to the sweep roller, in the case of a plus toner). There is also a method of applying a bias for discharging electricity with the same polarity as that of the toner. Furthermore, since the carrier solution adheres to the roller, the intermediate transfer roller 51, secondary transfer roller 55, and intermediate transfer body sweep roller are provided with a cleaning member constituted by a metal blade or rubber blade, to thereby remove the adhered carrier solution. Each cleaning member may not only be a blade but also a roller.

The intermediate transfer roller 51 may be configured simply by forming a conductive elastic layer made of a rubber or resin on a conductive drum made of metal or the like, but it is also desired to further provide a surface layer with a layer which has low tacking property and less surface roughness and adjusts resistance. A belt-like layer which is formed of conductive rubber or resin may be used. In the case of the belt-like layer as well, the above-described layer may be provided on the surface layer. If the intermediate transfer body is in the form of a drum, there are advantages such as good rotational accuracy, good positional reproductivity, and easiness of applying high pressure. On the other hand, a belt-like intermediate transfer body is advantageous when performing transfer from a plurality of photoconductors to one intermediate transfer body to form a color image, or when increasing the width of the nip. The material of the elastic conductive layer is, for example, hydrin, urethane, NBR, chloropropylene rubber, silicone rubber, EPDM, and the like. The material of each elastic rubber is not limited to the examples described above, and thus may be a conductive material which does not swell or dissolve in a carrier solution/developer. Moreover, if the surface of the intermediate transfer body has conductivity and is configured by a material which does not swell or dissolve in a carrier solution/developer, and the carrier solution/developer does not come into contact with an inner layer of the intermediate transfer body, then the material of each elastic layer as the inner layer may not have any restriction in the conductivity/swelling and dissolving, and thus only needs to have elasticity. At this moment, a bias voltage to be applied to the intermediate transfer body needs to be applied from the surface of the intermediate transfer body, not from an axis of the intermediate transfer body. It is desired that the hardness of the rubber in this elastic layer be 50 degrees or less as measured by JIS-A hardness. The reason is to provide a transfer nip, thus, when using a belt-like intermediate transfer body, it may have hardness enough to drive, bend, or function in different forms as a sheet.

The surface roughness of the intermediate transfer roller 51 is preferably 0 through 4 [um] in the ten point height of roughness profile. This is because, when using the liquid developer, the thickness of toner image formed on the intermediate transfer roller 51 may be 5 [um] or less or sometimes approximately 2 [um], and if the surface is rough regardless of thickness of the toner image, the image may be damaged. More desirably, the surface roughness is 1 through 2 [um] in the ten point height of roughness profile. If the surface roughness is too low, the tacking property may increase.

If the electric resistance of the intermediate transfer roller 51 is within a range of a volume resistivity of 1×10⁷ through 1×10¹¹ [Ω·cm], transfer from the photoconductor drum 1 (primary transfer) and transfer to the transfer paper P (secondary transfer) can be performed well, but if the electric resistance is desirably within a range of 1×10⁸ through 1×10¹⁰ [Ω·cm], less transfer defects occur and only a small amount of electricity is required. If the electric resistance is equal to or lower than 1×10¹⁰ [Ω·cm], a transfer defect may occur depending on the environment such as humidity, but if the electric resistance is 1×10¹⁰ [Ω·cm] or above, an abnormal electrical discharge may occur depending on the environment, wasting the electricity. The surface resistivity is 1×10⁹ through 1×10¹² [Ω·cm], or preferably 1×10¹⁰ through 1×10¹¹ [Ω·cm]. These volume resistivity and surface resistivity are obtained by measuring a value 10 seconds after applying a voltage of 250 [V] using a high resistivity meter (Hiresta UP MCP-HT450, measuring probe: UR-SS) manufactured by Mitsubishi Chemical Corp.

As the material of the intermediate transfer roller 51, if there is a problem in the surface roughness, smoothness on the surface, or other problems, other layer (surface layer) may be provided on the surface of the intermediate transfer roller 51. When an elastic body is used, it is difficult to improve the surface roughness, and the tacking property becomes strong. Therefore, in order to solve such a problem, for example, preferably, a coat layer or film layer with a thickness of several [um] through several [mm] using a fluorine resin, or an elastic layer made of different material is provided. In this case, the intermediate transfer roller 51 consists of three layers, i.e., base body+elastic layer+surface layer. To raise an example using the intermediate transfer roller 51, preferably the base body is a metallic drum, the resistivity of the entire intermediate transfer body obtained after providing the surface layer is adjusted to the above-mentioned volume resistivity and surface resistivity, and the resistivity of the elastic layer is as low as possible in order to lower time constant.

A primary transfer bias for transferring a toner image from the photoconductor drum 1 to the intermediate transfer roller 51 is applied from an unshown bias power source at a polarity opposite to that of the toner (−). The potential difference therebetween is within a range of, for example, +100 [V] through +500 [V]. Further, the optimum value thereof varies according to the material of a charging toner or of the intermediate transfer roller 51.

The secondary transfer from the intermediate transfer roller 51 to the transfer paper P is performed by a secondary transfer section which is configured by the secondary transfer roller 55 as a recording body transfer member, an unshown secondary transfer power source connected to the secondary transfer roller 55, and the like. As the secondary transfer roller 55, a metallic roller, or a rubber roller made of hydrin, NBR or the like and having a hardness of 30 through 70 degrees as measured by JIS-A hardness is used. The volume resistivity of the secondary transfer roller 55 is preferably within a range of 1×10² through 1×10⁷ [Ω·cm]. If the volume resistivity is too low, the resistance of the transfer paper P may become low, or the secondary transfer roller 55 may directly abut against the intermediate transfer roller 51 without having the transfer paper P therebetween, whereby the potential difference may not be maintained and eventually the transfer rate may decrease. If the volume resistivity is too high, high voltage becomes necessary. Moreover, the transfer rate may decrease due to the occurrence of an abnormal electrical discharge or the like.

In the secondary transfer step of transferring the toner image supported on the intermediate transfer roller 51 to the transfer paper P, the secondary transfer roller 55 abuts against the intermediate transfer roller 51 with an unshown conveying belt therebetween, to thereby form an abutment nip. Then, the transfer paper P, which has been conveyed by the conveying belt from an unshown paper cassette, is fed to the abutment nip between the intermediate transfer roller 51 and the secondary transfer roller 55 at a predetermined timing, and at the same time a secondary transfer bias is applied from the unshown bias power source to the secondary transfer roller 55. By this secondary transfer bias, the toner image is transferred from the intermediate transfer roller 51 to the transfer paper P.

Secondary transfer voltage to be applied to the secondary transfer roller 55 has a polarity opposite to that of the toner with respect to the voltage to be applied to the intermediate transfer roller 51, and is applied so that the potential difference becomes +200 [V] through +3000 [V]. The optimum value thereof varies according to various conditions such as the environment including humidity, the thickness or material of the recording body such as the transfer paper P, the condition of the water content, the charge amount of the toner, the amount of the developer, and the amount of the carrier solution in the developer. Constant current control may be performed so as to be able to handle various recording bodies. The optimum value of current varies if the constant current control is performed, but optimum transfer is often obtained with the value of approximately 100 through 1000 [uA]. In the present embodiment 1, an image is created by performing constant current control with a value of 200 through 300 [uA]. After image transfer to the transfer paper P is finished, the residual transferred toner on the intermediate transfer roller 51 is cleaned off by an abutment of an intermediate transfer body cleaning blade 52 or the like.

The transfer paper P, which has passed through the secondary transfer nip and received the transfer of the toner image, is guided to the fixing apparatus 90, applied with a fixer 93, has the toner image fixed thereon, and is then ejected to the outside of the apparatus, the fixer 93 being obtained by diluting a softener, which has a characteristic of softening resin particles for forming a toner, with a diluting solution, which is a diluent. Furthermore, the fixer 93 in which the softener is dispersed in a fluid composition may be used, the fluid composition of the fixer 93 being a composition in which the softener hardly dissolves. The fluid composition, which is a dispersing agent for dispersing the softener, is called “dispersing solution” hereinafter.

As shown in FIG. 1, in the printer of the present embodiment 1, the fixing apparatus 90 is disposed on the downstream side of the secondary transfer section in the moving direction on the surface of the transfer paper P. This fixing apparatus 90 comprises a fixing roller 91, which is fixer application means disposed so as to abut on the surface of the transfer paper P via the developer and fixer 93. The fixing apparatus 90 is configured in a movable manner by an unshown driving mechanism so that the fixing roller 91 can approach or separate from the surface of the transfer paper P. The fixer 93 is stored in a fixer tank 95 of the fixing apparatus 90, and the fixing apparatus 90 is disposed in a state in which a feed roller 92 for feeding the fixer to the fixing roller 91 is immersed in the fixer 93.

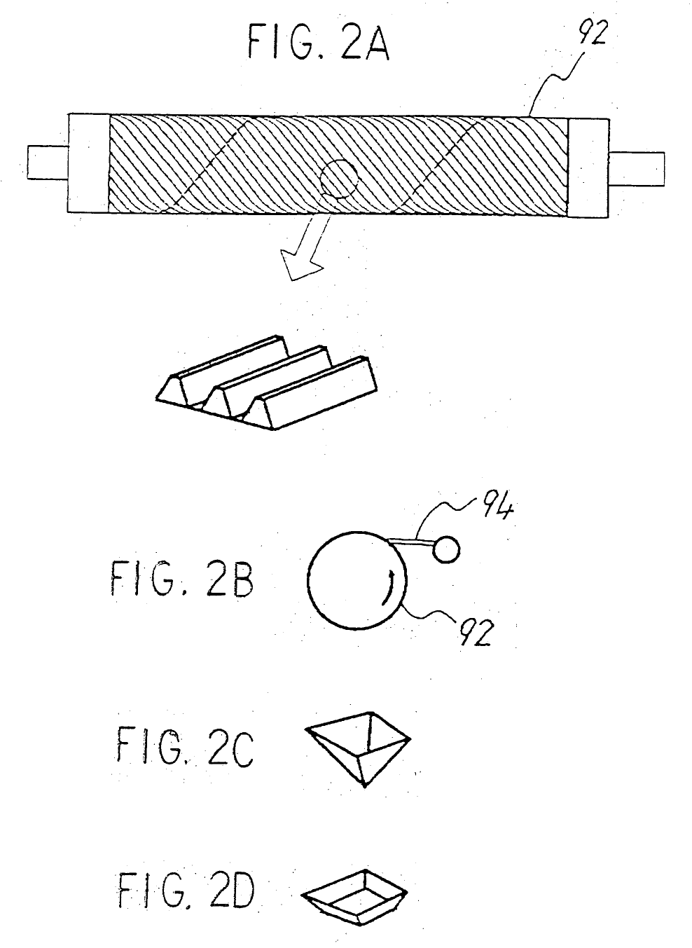

Next, the feed roller 92 is explained with reference to FIGS. 2A through 2D.

As shown in FIG. 2A, on the surface of the feed roller 92, fine grooves are formed in a uniform pattern. As shown in FIG. 2B, a scraping blade 94 is in contact with the surface of the feed roller 92. This feed roller 92 is disposed so as to come into contact with the surface of the fixing roller 91, in a state in which the feed roller 92 is immersed in the fixer 93 inside the fixer tank 95. The fixing roller 91 and the feed roller 92 are driven to rotate in the direction shown by an arrow in the figure, when applying the fixer 93 to the toner. Accordingly, the fixer 93 is drawn up to the surface of the feed roller 92.

The fixer 93, which has been drawn up in this manner, is poured into the groove section on the surface of the feed roller 92 and thereby supported, while the fixer 93 adhering to the outside of the groove section is scraped off by the scraping blade 94. Then, as the feed roller 92 rotates, the fixer 93 on the feed roller 92 is conveyed to a position where the feed roller 92 contacts with the fixing roller 91. At this position of contact, the feed roller 92 and the fixing roller 91 move the surfaces thereof in the counter direction, and the fixer 93 inside the groove section of the feed roller 92 adheres to the surface of the fixing roller 91. Therefore, by adjusting the volume of the inside of the groove provided on the surface of the feed roller 92, the amount of fixer on the fixing roller 91 can be adjusted.

It should be noted that FIG. 2A shows the fine grooves of the feed roller 92 with dashed lines, but the feed roller 92 may have pyramid-shaped fine grooves as shown in FIG. 2C or lattice-shaped grooves as shown in FIG. 2D.

When the fixing roller 91 is used as the fixer feeding means for feeding the fixer 93 to the toner on the transfer paper P, the toner image supported on the transfer paper P may be distorted. Therefore, in the present embodiment 1, the fixing roller 91 and an opposing roller 96 in which the base body configured by the conductive material is covered with an insulating layer or high-resistance layer are used, and a fixing roller power source 97 and an opposing roller power source 98 which function as electric field forming means are connected to the fixing roller 91 and the opposing roller 96 respectively. Also, one of them maybe connected to the ground, as shown in FIG. 1.

Specifically, as the fixing roller 91 and the opposing roller 96, the ones in which the surface of a conductive rubber layer formed on a stainless cored bar is covered with an insulating PFA tube can be used. By this configuration, between the fixing roller 91 and the transfer paper P, an electric field is formed in a direction of pressing the toner against the opposing roller 96.

By forming such an electric field, a restraint force of the toner against the transfer paper P can be increased, the toner being positioned on the transfer paper P in an agent feeding position. Accordingly, the fixer 93 can be fed to the toner without distorting the toner image supported on the transfer paper P.

The fixing apparatus 90 may wait in a state in which the fixing roller 91 and the opposing roller 96 are separated from each other, until the transfer paper P is conveyed. Then, the fixing apparatus 90 uses the unshown driving mechanism to move the fixing roller 91 to a position adjacent to the surface of the transfer paper P, immediately before an edge of the transfer paper P reaches a position facing the fixing roller 91. Accordingly, the fixer 93 on the fixing roller 91 is fed onto the surface of the transfer paper P.

In this manner, in the method of feeding and fixing the fixer 93 onto the toner image on the transfer paper P, heat processing, which involves a significant electric power consumption as with the heat fixing system, is not required, thus this method is an excellent fixing system in terms of an energy-saving strategy. Further, a warm-up period is not required while it is required in the heat fixing system, thus a quick start can be performed.

However, if a volatile fixer is used as the fixer for dissolving or swelling the toner, the odor or safety problems arises. Moreover, in order to prevent the volatile matters from spreading out through the outside of the apparatus for the sake of safety, it is required to make the apparatus have a sealed structure for safety. Also, a problem of volatility may arise at the time of saving, and changes of the density may become also a problem during use of the apparatus. It should be noted that there arises a problem, when an aqueous fixer is used, that wrinkles may be generated on the transfer paper and thus a drying process may be required when the aqueous fixer adheres to the transfer paper. There is also a problem that unpleasant odor or air pollution may be caused when the drying process is performed.

Therefore, as the fixer 93 to be applied onto the transfer paper P, by using a nonvolatile fixer along with a softener or diluting solution (or dispersing solution), reduction of the density caused by evaporation of the softener, or increase of the density caused by evaporation of the diluting solution (or dispersing solution) is prevented, thus the density of the softener inside the fixer 93 can be kept uniform. Further, since the softener and diluting solution (or dispersing solution) do not evaporate, the advantages are that the fixer 93 has a good keeping quality, that air pollution is not caused, and that substantially no odor is caused. Also, since the fixer 93 does not evaporate, the softener can be securely brought into contact with the toner, and thereby the toner can be softened effectively, while the conventional fixer vaporizes quickly.

At this moment, the fixer is considered to be absorbed in the transfer paper. Further, swelling of the transfer paper by the fixer used in the fixing apparatus 90 was hardly observed. Moreover, even when the fixer is applied directly onto the transfer paper, a drier is not required, and the paper is not wrinkled because it hardly swells.

On the other hand, when using a fixer containing a volatile substance such as water, the transfer paper is swollen by the water, and, when drying the transfer paper, the transfer paper dries while the swollen and extended part thereof does not return to normal. Alternatively, a part of the transfer paper shrinks and dries, whereby wrinkles, waviness, or surface irregularity occurs on the transfer paper.

It should be noted that, as the softener of the fixer 93, by using a fixer having an affinity for the carrier solution of the liquid developer forming a toner image, the softener easily penetrates into the carrier solution, and the time period in which the softener reaches resin particles of the toner can be reduced, whereby the time period required for softening the toner can be reduced. Accordingly, the fixing speed can be increased.

Moreover, in the case in which the fixing apparatus 90 is provided on the downstream side of the secondary transfer nip as shown in FIG. 1, as compared to the case in which the fixing apparatus 90 is provided on the upstream side of the secondary transfer nip, the fixing time period becomes shorter if the medium for fixing a resin such as a transfer paper is made of a material absorbing the softener/fixer. The reason is that, since the fixer 93 containing a softener has an affinity for the liquid developer, the resin is dissolved/swollen even when the fixer is immersed in the transfer paper or the like, but it takes a certain amount of time for the softener in the fixer 93 to contact with the resin when the resin is adhered to the transfer paper or the like after applying the fixer 93.

Having an affinity for the carrier solution means that the fixer has a property of not separating from the carrier solution even if mixed with the carrier solution.

Next, the fixer 93 containing the softener is described.

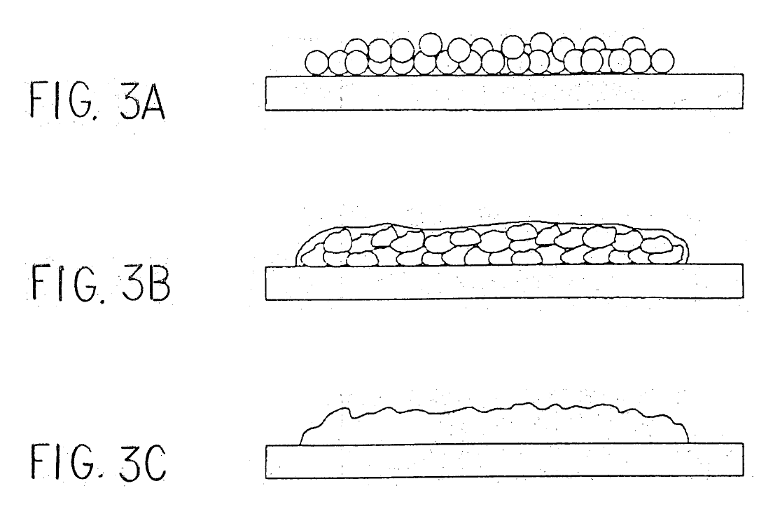

FIGS. 3A through 3C are figures showing temporal changes of the fixer 93 and toner when the fixer 93 is applied to the toner. FIG. 3A shows a state in which a substance containing a resin is placed on a member to which the substance is fixed, and FIG. 3B shows a state in which the fixer 93 is applied to the resin. The resin is softened by the fixer 93 and thereby has adherence, the fixer 93 is then ejected from the resin, and the resin is changed into a film-like form. FIG. 3C shows a state in which the resin is changed into a film-like form.

By forming a toner into a film-like toner on the transfer paper P, the toner can be fixed onto the transfer paper P.

Next, the softener contained in the fixer 93 is described.

The softener contained in the fixer 93 is a material for dissolving or swelling a resin component configuring the toner (referred to as “softener” hereinafter). It is desired that this softener be a material which does not vaporize or cause odor and has an affinity for the carrier solution configuring the liquid developer. As a specific example of this dissolving/swelling component, there are saturated aliphatic ester, aliphatic dicarboxylic acid ester, and the like.

As the softener, the saturated aliphatic ester can be used.

The saturated aliphatic ester is a compound expressed by a general formula, “R1COOR2”, wherein, R1 is an alkyl group having 11 to 14 carbon atoms, and R2 is an alkyl group having 1 to 3 carbon atoms.

Examples of aliphatic monocarboxylic ester, which is the saturated aliphatic ester, include ethyl laurate, ethyl tridecylate, isopropyl tridecylate, ethyl myristate, isopropyl mysristate, and the like. These compounds hardly vaporize, have an affinity for silicone oil, PAO, or other synthetic oil, mineral oil, and hydrocarbon solvent, and are dissolved in dimethyl silicone, mineral oil, Isopar, and the like which are used as the carrier solution. These compounds are insoluble and the solubility thereof in water is 0.1 g/100 ml (25° C.) or less.

The aliphatic dicarboxylic acid ester, which is the saturated aliphatic ester, is a compound expressed by a general formula, “R3 (COOR4) 2”, wherein, R3 is an alkylene group having 3 to 8 carbon atoms, and R4 is an alkyl group having 2 to 5 carbon atoms.

Examples of the aliphatic dicarboxylic acid ester include di-isobutyl adipate, diisopropyl adipate, diethyl sebacate, dibutyl sebacate, and the like. Most of these components hardly vaporize, and are dissolved in silicone oil, PAO, or other synthetic oil, mineral oil, and hydrocarbon solvent. These components are insoluble and the solubility thereof in water at 25[° C.] is 0.1 [g/100 ml] or less.

It should be noted that in any of the above-described saturated aliphatic esters, the larger the number of carbon atoms, the higher the viscosity and nonvolatility. Moreover, the odor of these saturated aliphatic esters can be reduced by refining, and some esters with a high degree of purity are nearly odorless.

The above examples of the softener are liquid softeners. By using a liquid softener as the softener, the softener easily penetrates into the carrier solution and thereby quickly comes into contact with the toner, compared to the case where the softener is a solid or gel softener. Even in the case of a liquid softener, the speed of penetration thereof depends on the viscosity or surface energy, thus the lower the viscosity the higher the speed of penetration. If the fixer is the liquid fixer 93, it can be fed easily by using a pipe or pump. Also, the liquid fixer is very useful because it does not scatter like powder. Furthermore, by using the fixer, it is easy to restrict the quantity thereof when forming a thin layer or the like. Compared to powder, the softener can be mixed into the carrier solution easily and thereby easily comes into contact with the resin particles forming the toner.

Next, the diluting solution for diluting the softener, or the dispersing solution for dispersing the softener is explained. As the diluting solution configuring the fixer 93, nonvolatile diluting solution is used.

When the required amount or more of the dissolving/swelling component for softening the toner is fed to a resin to fix the toner thereon, hardening of the resin is slowed and as a result it requires a long time to fix the toner. The resin for fixing the toner thereon is desirably in a semi-dissolved state or swollen state. Depending on the types of the dissolving/swelling components, it is sufficient that the amount of the dissolving/swelling component be generally less than half the amount of the toner.

It should be noted that if the amount of the dissolving/swelling component to be fed is not at least half or more of the amount of the toner, the dissolving/swelling component which is not capable of softening the toner is not suitable for a treatment of the dissolving/swelling component obtained after softening the toner. For example, the amount of toner for configuring a toner image on the photoconductor drum 1, intermediate transfer roller 51, and transfer paper P is desirably a few [μm] levels in thickness, and the dissolving/swelling component is desirably fed thinner in thickness and smaller at an amount than the toner.

Although it is desired that the dissolving/swelling component be fed thinner in thickness and smaller at an amount, it is extremely difficult to uniformly feed a small amount of softener which is the dissolving/swelling component.

Therefore, as a method of feeding such a small amount of dissolving/swelling component, generally, there is used a method of diluting the softener, which is this dissolving/swelling component, by using some sort of liquid. As the diluting solution, there is known the one using water in consideration of an impact on the environment. However, sine water easily vaporizes, the density changes easily, and other problem is the keeping quality of the agent for dealing with decay and the like.

Further, if using a dispersing solution/diluting solution having a good affinity for water when mixed with water, and also having good solubility, the water is easily absorbed, whereby the moisture in the air is absorbed and the thereby the density changes easily.

Furthermore, the dispersing solution or diluting solution may not be applied evenly because of the surface energy of after-mentioned photoconductor, intermediate transfer body, or film-like recording body. When using a transfer paper, there may arise a problem that the paper is cockled (wrinkled).

Moreover, when using a volatile diluting solution other than water, there arises a problem that the diluting solution vaporizes, causing odor or air pollution. The examples of a dispersing solution/diluting solution which does not vaporize, is insoluble in water, and hardly causes odor, include silicone oil, mineral oil, and the like. Both oils have various structures and grades (viscosity/molecular weight). In the embodiment 1, solution, which is obtained by mixing 50[%] of the abovementioned softener with 50[%] or less of silicone oil 50 cSt as the diluting solution, is used as the fixer 93.

It should be noted that if the softener is liquid, only the softener can be used as the fixer 93. However, the amount of resin on the transfer paper P is extremely small, thus it is difficult to feed the amount of softener which is smaller than that of the resin. Therefore, by diluting the softener using an appropriate amount of diluting solution, and feeding the obtained solution as the fixer 93, a required amount of softener is contained in the fixer, the amount of which can be stably fed.

As the example of the dispersing solution/diluting solution, in silicone oil, the bond angle between atoms is large, the space between the atoms is also large, the outside of spiral molecules is covered by a methyl group, and the attracting force between the molecules is week, thus the surface tension is low. For this reason, when the silicone oil is applied to a mass of resin, good wetting properties are obtained and the fixer can be applied uniformly.

In the case of dimethyl silicone as an example of the silicone oil, there is, for example, SH200 (product name) manufactured by Dow Corning Toray Co., Ltd. According to the catalogue values therein, in the case of SH200-100cs (product name) having a kinetic viscosity of 100 [mm2/s] (25[° C.]), the volatile portion thereof at 150[° C.] 24 [hours] is 0.5[%] or less, thus most of this product does not vaporize. Similarly, the volatile portion of SH200-50cs (product name) at 150[° C.] 24 [hours] is also 0.5[%] or less, thus this product is desired as the diluting solution (or dispersing solution). Moreover, the volatile portion of SH200-20cs (product name) at 150[° C.] 24 [hours] is 6[%], but the volatile portion of same at normal temperature was 0.1[%] or less in 120 [hours] as well, when measuring it in the lab with a temperature of approximately 25[° C.] and a humidity of approximately 60[%]. Therefore, this product can be used as the diluting solution (or dispersing solution). Dimethyl silicone is the most typical silicone oil having the characteristics such as transparent and colorless characteristics, tasteless and odorless characteristics, low surface tension characteristics, flatting characteristics, chemical/thermal stability, permeability, water repellency, and nonvolatility. Further, methylphenyl silicone has water repellency and lubricating properties which are specific to silicone, and has better compatibility with other organic components. Stabilized combination of silicone oil can be improved by a function of the compatibility between the dimethyl silicone oil and organic oil/wax component, thus methylphenyl silicone is advantageous when using a plurality of various diluting solutions.

The carrier solution is adhered to the toner on the transfer paper, after-mentioned photoconductor drum 1, or intermediate roller 51 fed with the fixer 93. Therefore, when using, for example, water as the diluting solution (or dispersing solution) which is the dissolving/swelling component in the fixer 93, since the carrier solution (dimethyl silicone oil, mineral oil, Isopar, or the like) of the liquid developer is generally oil, the fixer is repelled by the carrier solution. As a result, it requires a long time for the softener, which is the dissolving/swelling component of the fixer, to reach the toner, requiring a long time for the fixer to soften the resin particles of the toner. It should be noted that when using, as the diluting solution (or dispersing solution), not only water but also a substance which is not mixed easily with the carrier solution, it requires a long time to soften the resin particles of the toner for the same reason.

Moreover, when using water as the diluting solution (or dispersing solution), if the moisture is mixed into the carrier solution, the insulating properties of the carrier solution are lost, and as a result, the charging properties of the toner change, whereby control of the developing electric field or transfer electric field becomes difficult. Furthermore, although there is no particular problem with the transfer paper P even when water adheres thereto, if cleaning is not performed sufficiently by using the drum cleaning apparatus 60 after transferring the toner image formed on the photoconductor drum 1 onto the intermediate transfer roller 51, the surface of the photoconductor drum 1 having moisture is used in the subsequent image formation step. Accordingly, image formation itself may become complicated. Similarly, when water adheres to the intermediate transfer roller 51, if cleaning is not performed sufficiently by using the intermediate transfer body cleaning blade 52, the surface of the intermediate transfer roller 51 having moisture is used in the subsequent image formation step. Accordingly, a normal transfer electric field cannot be formed, whereby good transfer cannot be performed.

Therefore, by using, as the diluting solution (or dispersing solution), the one having an affinity for the carrier solution, the above problems can be solved. Accordingly, the diluting solution (or dispersing solution) can be mixed easily with the carrier solution, and the time required for the softener in the fixer 93 to reach the resin particles of the toner in the liquid developer can be reduced, whereby the fixing speed can be increased.

Also, as the diluting solution (or dispersing solution) of the softener which is the dissolving/swelling component, the one same as the carrier solution of the liquid developer is used. As the diluting solution (or dispersing solution) of the fixer 93, by using the one which is same as the carrier solution of the liquid developer, the softener inside the fixer 93 can be brought into contact with and caused to penetrate into the toner promptly because the fixer 93 has an affinity for the carrier solution. Then, the resin component of the toner can be softened promptly, and, since the fixer 93 also functions to cause the carrier solution present between toner particles to flow out, binding between the toner particles can be promoted. Accordingly, the softening time period can be reduced, and the fixing properties improve more, compared to the case in which heat fixing is performed without removing the carrier solution.

It should be noted that the inventors of the present invention consider that the fixer functions to cause the carrier solution present between the toner particles to flow out, in view of that “the fixing is obstructed by silicone oil between toner particles”, and that “the silicone oil dissolves in the softener, and chemical fixing produces better fixing properties than heat fixing when obtaining the best fixing properties (the fixing properties obtained in chemical fixing cannot be achieved in heat fixing)”.

Furthermore, the inventors consider that, by changing the arrangement of the molecular chain of the toner resin by means of the softener, the binding state between the resin and carrier solution change (weakens), and the carrier solution and fixer are dissolved, whereby the solvent obtained by dissolving the fixer and carrier solution penetrates a paper. The softener which is used in the fixing apparatus 90 has lower viscosity (14 [mPa·s] or the like) than the carrier solution (50 [mPa·s]), thus it is considered that the viscosity of the fixer (unmeasured) is also lower than that of the carrier solution. Also, it is considered that the carrier solution between the toner particles is flowed out due to the low viscosity of the fixer and good affinity thereof for the carrier solution. It is also considered that the carrier solution between the toner particles can be removed easily because of the affinity between the fixer and carrier solution.

Since the fixing speed can be increased as described above, the speed of image formation can be improved.

Particularly, in the configuration of applying the fixer 93 to the toner image formed on the after-mentioned photoconductor drum 1, the time period for a conveyance from a fixer feeding position to the primary transfer position can be reduced, whereby the length of the photoconductor drum 1 between the fixer feeding position and the primary transfer nip can be reduced. Accordingly, the diameter of the photoconductor drum 1 can be reduced, and the size of the entire image forming apparatus can be reduced. Moreover, in the configuration of applying the fixer 93 to the toner image formed on the after-mentioned intermediate transfer roller 51, the time period for a conveyance from the fixer feeding position to the secondary transfer position can be reduced, whereby the length of the intermediate transfer roller 51 between the fixer feeding position and the secondary transfer nip can be reduced. Accordingly, the diameter of the intermediate transfer roller 51 can be reduced, and the size of the entire image forming apparatus can be reduced.

As in the present embodiment 1, by using, as the diluting solution (or dispersing solution) of the fixer, a substance, which is same as the carrier solution of the liquid developer, the charging properties or the like of the toner are no longer changed.

Examples of the carrier solution of the liquid developer include Isopar (product name) manufactured by Exxon Corporation, mineral oil, and PAO. As the Isopar, Isopar V, for example, can be used as a nonvolatile carrier solution since the volatility thereof is 2[%] or less by being let stand overnight at 25[° C.] (under normal temperature and normal pressure: 25[° C.], 1 [hectopascal]), and the volume resistivity is 1×10¹³ [Ω·cm]. PAO is a poly α olefin obtained by polymerizing α olefin. It is oil which has been conventionally used as the base oil of chemical synthetic oil. The poly α olefin having 10 carbon atoms is used because it is excellent in viscosity index and flow point. The poly α olefin is generally used because it can be obtained inexpensively and effectively by using a method of polymerizing ethylene, although it can be also obtained by degrading mineral oil.

The fixing apparatus 90 uses insulation liquid as the diluting solution configuring the fixer 93, the insulation liquid being used in the carrier solution of the liquid developer. Specifically, the nonvolatile dimethyl silicone used as the carrier solution of the liquid developer is used as the diluting solution of the fixer. In silicone, the binding energy between molecules is large and the bond is hardly broken, thus the silicone is strong to heat and has high electrical insulation. Further, the silicone has particularly good wetting properties because of the weak surface energy thereof, and the softener contained in the fixer can quickly reach the toner covered by the carrier solution. Therefore, the time period required for softening the resin component of the toner by means of the fixer can be reduced. Furthermore, by using the nonvolatile dimethyl silicone as the diluting solution and carrier solution of the fixer, the environment is not harmed. The dimethyl silicone is suitable as the carrier solution since the volume resistivity thereof is 10¹⁴ through 10¹⁶ [Ω·cm]. Also, by using nonvolatile liquid, it is not necessary to provide a mechanism for recovering the volatile component.

Methylphenyl silicone can also be used as the carrier solution similarly. Methylphenyl silicone is suitable for producing liquid developer by being mixed with toner, because it has high refractive index because of the presence of the phenyl group, has high compatibility with other organic components, and thereby improves combination stability. Also, the methylphenyl silicone is excellent in the temperature properties thereof, and thus is hardly oxidized even at 300[° C.] in 500 [hours]. Furthermore, fluorosilicone oil can be used as the carrier solution. Fluorosilicone oil has a fluoro group (CF3) in the structure thereof and has a larger dielectric constant of 50 [HZz], compared to other silicone oil. There are other denatured silicone oil, but these denatured silicone oil may have reactive branched chains or terminal groups. Silicone oil having relatively a small reactivity is selected above.

The nonvolatile fixer used in the present embodiment 1 softens the resin and is partially introduced to a resin layer, but the inventors consider that most of the fixer is ejected from the resin layer, whereby the resin layer becomes solidified. Therefore, when dissolving/swelling the toner on the surface or the like of the photoconductor or intermediate transfer body as described hereinafter, the photoconductor and intermediate transfer body do not absorb the fixer. Therefore, the fixer which is ejected and isolated from a toner image is partially split and reduced when transferring the toner image. Also, there is a method of removing the fixer provided after dissolving/swelling, by means of a mechanism of removing the fixer. However, when applying the fixer to a medium which absorbs the fixer as with the transfer paper, it is difficult to recover an excess amount of fixer after application.

Moreover, since the fixer is nonvolatile, it does not disappear unless it is recovered. Therefore, when applying the fixer to a transfer paper or a medium for fixing a resin thereon, the amount of fixer applied is preferably enough to be held on the medium for fixing the resin thereon. For example, when fixing a toner layer formed on a transfer paper, although the amount of fixer varies depending on the oil absorbing properties and thickness of the transfer paper, the fixer may be applied at an amount or lower which is sufficient for the transfer paper to absorb the softening fixer. In order to do so, although depending on the power of the softener to dissolve/swell the resin, in the case of dispersing/diluting the softener and using it as the fixer, the ratio between the softener and fixer is changed to adjust the amount of the softener and fixer such that the softener is contained at an amount sufficient for dissolving/swelling the resin and yet the amount of fixer is not excessive. If the amount of fixer is equal to or less than the amount sufficient to be absorbed by the paper, the mechanism of recovering the excess liquid after dissolving/swelling the resin is not required. If the amount of fixer is excessive, the resin is not solidified even after dissolved/swollen, thus the resin is not fixed and thereby spreads out or is scraped off when scratched.

[Experiment 1]

Here, Experiment 1 is carried out to measure the amount of liquid that a transfer paper can absorb.

As this liquid, silicone (50 [mPa·s]), which is used as the diluting solution of the fixer, was used, and, as the transfer paper, T-6200 produced by Ricoh was used. The amount of the liquid to be adhered to the transfer paper was changed to evaluate the leakage on the paper.

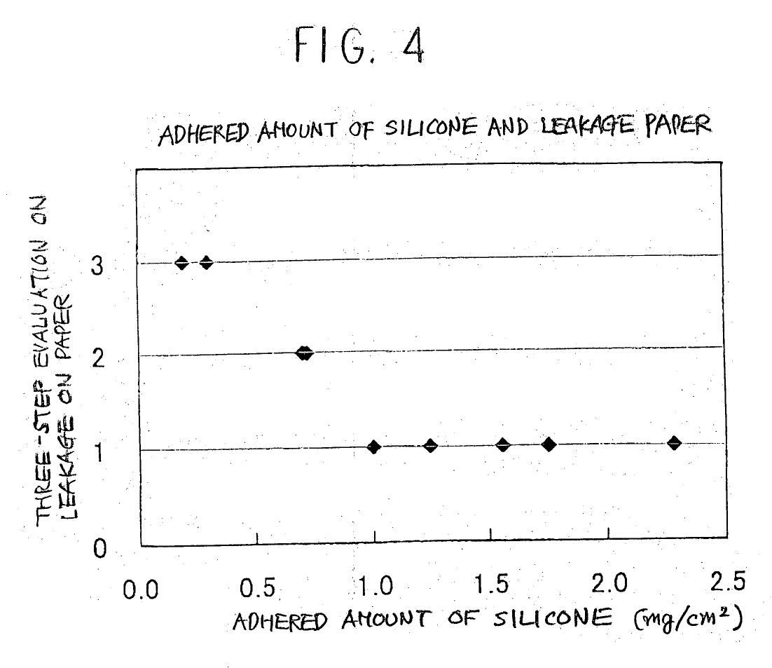

The results of Experiment 1 are shown in FIG. 4.

In FIG. 4, the horizontal axis shows the adhered amount of silicone oil per unit area of the transfer paper, while the vertical axis shows three steps of evaluation on the leakage on the paper. In the three-step evaluations with eyes, 1 indicates “unacceptable: leakage observed on paper surface, and further leakage observed in one minute”, 2 indicates “acceptable: leakage observed in the immediate aftermath, but the liquid penetrates the paper in a few seconds, thus drying may be unnecessary”, and 3 indicates “good: almost no leakage observed in the immediate aftermath”.

As a result of Experiment 1, if the amount of silicone is 0.7 [mg/cm²] or less, the leakage is at least 2, which is a degree at which drying is not necessary. When using other type of paper to convert, per unit area, the adhered amount of liquid and the paper density to the ratio of the adhered amount of liquid with respect to the mass of the paper, the adhered amount is approximately 1[%] of the fixer with respect to the paper at present, thus almost no leakage is observed. The maximum leakage is observed when the fixer is approximately 10[%], thus 3[%] or lower of the fixer is desired. Therefore, out of the transfer materials which are commercially available in general, it is necessary to configure the thinnest transfer material such that the fixer can be applied at an amount at which the feeling of leakage is not obtained, and it is necessary to select a developer with which satisfactory fixing properties can be obtained at the abovementioned amount.

[Modification 1]

In the present embodiment 1, liquid fixer is used as the fixer. Most of the softeners and the substances for dispersing/diluting as described above are in the form of liquid at normal temperature. The fixer is not necessarily liquid. Hereinafter, Modification 1 in which gel fixer is used is explained.

Liquid softener or fixer is applied well and spread well onto a resin. However, when the resin is, for example, in the form of particles, the resin particles are caused to flow out, moving the toner or ink. If the toner or ink which forms an image on the transfer paper is moved, the image is distorted. In such a case, therefore, the fixer is configured in the form of gel, and is then adhered to the resin without moving the resin particles or distorting the image, and then fixed to the resin. In order to configure the fixer in the form of gel, there is a method of using oil-absorbent polymer (a polymeric substance which absorbs a greasy substance or which is melted into a greasy substance to form the greasy substance into gel). Examples of the oil-absorbent polymer include cross-linking substances for a polymer such as alkyl styrene, alkyl methacrylate, and hydroxyalkyl methacrylate, polyalkyl acrylate, polyisobutylene, and the like.

An example in which polyalkyl acrylate is used to form gel is shown. 2 [g] of polyalkyl acrylate is mixed into a 100 [ml] fixer, thus obtained mixture is heated at approximately 45[° C.], the heating is stopped when uniform solvent is obtained, and the solvent is left to be cooled down to room temperature. The gelled fixer can be applied to the photoconductor, intermediate transfer body, or a recording medium such as a transfer paper by using the application method in which the feed roller and fixing roller are used as with the present embodiment 1.

[Experiment 2]

Next, an experiment is performed in which the fixer used in the fixing apparatus of the present embodiment 1 is compared with a conventional fixer.

The experiment is performed with a configuration in which a wet printer shown in FIG. 1 is used as the experimental apparatus and the fixer 93 is applied to the transfer paper P after transferring a toner image. It should be noted that “nonvolatile” described herein means that the loss amount is 2[%] or lower at the normal temperature (20 through 25[° C.])/normal pressure in 48 hours.

Also, a smear test in each example and comparative example was evaluated by means of the following method.

An elastic material having a thickness of 5 [mm] is provided as a cushion material on an end of a clockmeter, and this end is covered with a cloth. The density on the cloth (three points average) was measured after rubbing on a solid image 10 laps back and forth (Dcrk), and the value obtained by subtracting the cloth density (Dls) from the measured amount is divided by original image density (Dinit). Thus obtained value Dsmr is taken as an evaluated value in the smear method. The smaller the value of Dsmr, the better the fixing properties, thus the current target value is 0.2 or less. It should be noted that the evaluated value Dsmr is obtained by the following equation.
Dsmr=(Dcrk−Dcls)/Dinit

### EXAMPLE 1

In this example, a formulation for the fixer having a good affinity for the liquid developer is employed.
Diisopropyl adipate (softener, LD50=5 [g/kg])

10 [wt/%]
Dimethylsiloxane (50 [mPa·s], diluting solution, LD50=15 [g/kg])

90 [wt/%]

The fixing apparatus was used to apply the abovementioned fixer at an adhered amount of 300 through 500 [mg/A4] to an unfixed image on the transfer paper, which is created by the printer 100 shown in FIG. 1, and the image was evaluated in a smear test. The time required for satisfying the smear target value was 2 [minutes] after application of the fixer. The loss amount in the volatility measurement was 1[%] or less, and odor was not detected at all.

### EXAMPLE 2

In this example, a formulation for the fixer having a good affinity for the liquid developer is employed.
Diisobutyl adipate (softener, LD50=12.3 [g/kg])

50 [wt/%]
Dimethylsiloxane (50 [mPa·s], diluting solution, LD50=15 [g/kg])

50 [wt/%]

The fixing apparatus was used to apply the abovementioned fixer at an adhered amount of 50 through 100 [mg/A4] to an unfixed image on the transfer paper, which is created by the printer 100 shown in FIG. 1, and the image was evaluated in a smear test. The time required for satisfying the smear target value was 1 [minute] or less. The loss amount in the volatility measurement was 1[%] or less, and odor was not detected at all.

### EXAMPLE 3

In this example, a formulation for the fixer having a good affinity for the liquid developer is employed.
Diisobutyl adipate (softener, LD50=12.3 [g/kg])
   50 [wt/%]
Isopar-V (14.8 [mpa·s], diluting solution)
   50 [wt/%]

The fixing apparatus was used to apply the abovementioned fixer at an adhered amount of 40 through 90 [mg/A4] to an unfixed image on the transfer paper, which is created by the printer 100 shown in FIG. 1, and the image was evaluated in a smear test. The time required for satisfying the smear target value was 1 [minute] or less. The loss amount in the volatility measurement was 1[%] or less, and odor was not detected at all.

### EXAMPLE 4

In this example, a formulation for the fixer having a good affinity for the liquid developer is employed.
Di-n-butyle sebacate (softener, LD50=14.9 [g/kg])
   20 [wt/%]
Dimethylsiloxane (50 [mPa·s], diluting solution, LD50=15 [g/kg])
   80 [wt/%]

The fixing apparatus was used to apply the abovementioned fixer at an adhered amount of 100 through 300 [mg/A4] to an unfixed image on the transfer paper, which is created by the printer 100 shown in FIG. 1, and the image was evaluated in a smear test. The time required for satisfying the smear target value was 3 [minutes] or less. The loss amount in the volatility measurement was 1[%] or less, and odor was not detected at all.

### EXAMPLE 5

In this example, a formulation for the fixer having a good affinity for the liquid developer is employed.
Di-n-butyle sebacate (softener, LD50=14.9 [g/kg])
   100 [wt/%]

The fixing apparatus was used to apply the abovementioned fixer at an adhered amount of 20 through 70 [mg/A4] to an unfixed image on the transfer paper, which is created by the printer 100 shown in FIG. 1, and the image was evaluated in a smear test. The time required for satisfying the smear target value was 2 [minutes] or less. The loss amount in the volatility measurement was 1[%] or less, and odor was not detected at all.

### EXAMPLE 6

In this example, a formulation for the gel fixer having a good affinity for the liquid developer is employed.
Diisopropyl adipate (softener, LD50=12.3 [g/kg])
   50 [wt/%]
Dimethylsiloxane (50 [mPa·s], diluting solution, LD50=15 [g/kg])
   48 [wt/%]
Polyalkyl acrylate (gelatinizing agent)
   2 [wt/%]

After mixing diisopropyl adipate with dimethylsiloxane, the entire mixture was heated at 45 through 50[° C.], and then the mixture was added with polyalkyl acrylate, stirred and left to be cooled down, whereby gelled fixer was obtained. The fixing apparatus was used to apply the abovementioned fixer at an adhered amount of 30 through 90 [mg/A4] to an unfixed image on the transfer paper, which is created by the printer shown in FIG. 1, and the image was evaluated in a smear test. The time required for satisfying the smear target value was 3 [minutes] or less. The loss amount in the volatility measurement was 1[%] or less, and odor was not detected at all.

### COMPARATIVE EXAMPLE 1

In this comparative example 1, a formulation for the fixer having a relatively bad affinity for the liquid developer is employed.
Diethoxyethyl succinate (softener, LD50=5 [g/kg])
   5 [wt/%]
Dimethylsiloxane (50 [mPa·s], diluting solution, LD50=15 [g/kg])
   95 [wt/%]

The fixing apparatus was used to apply the abovementioned fixer at an adhered amount of 300 through 400 [mg/A4] to an unfixed image on the transfer paper, which is created by the printer 100 shown in FIG. 1, and the image was evaluated in a smear test. The time required for satisfying the smear target value was 4 [minutes] or less. The loss amount in the volatility measurement was 1[%] or less, and odor was not detected at all.

### COMPARATIVE EXAMPLE 2

In this comparative example 2, a formulation using a diluting solution having a relatively bad affinity for the liquid developer is employed.
Diethoxyethyl succinate (softener, LD50=5 [g/kg])
   4 [wt/%]
Ethanol (diluting solution, LD50=20 [g/kg])
   20 [wt/%]
Water
   76 [wt/%]

The fixing apparatus was used to apply the abovementioned diluting solution at an adhered amount of 55 through 70 [mg/A4] to an image on the transfer paper, which is created by the printer 100 shown in FIG. 1, and the image was evaluated in a smear test. The time required for satisfying the smear target value was 5 [minutes] or less. Incidentally, the loss amount in the volatility measurement was approximately 10[%], and odor was detected. It should be noted that in this comparative example 2, curling and cockling were observed after fixing.

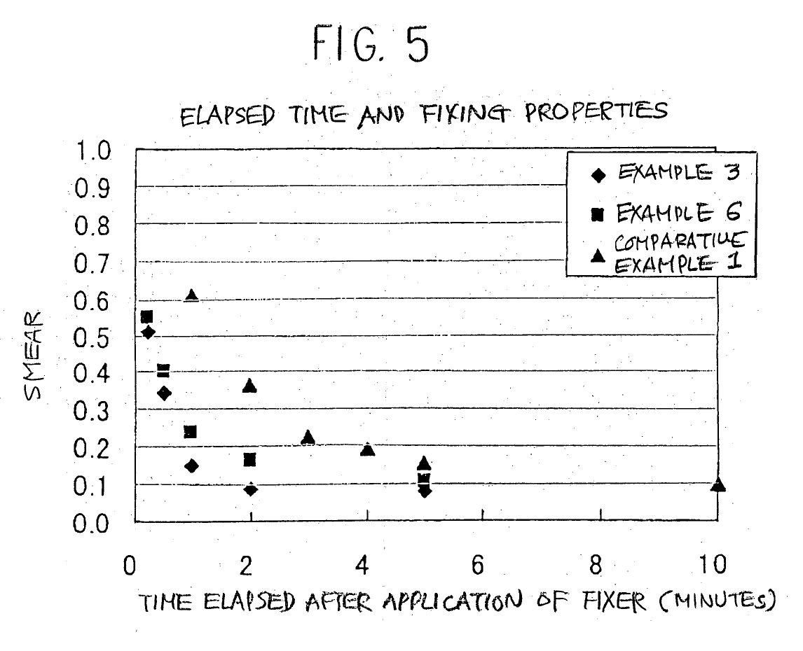

Out of the fixers evaluated in the above Experiment 2, the experimental results of the example 3, example 6, and comparative example 1 described above are shown in FIG. 5.

As shown in FIG. 5, even in the case of using any of the fixers, the elapsed time and the value of smear are reduced, but, after two minutes, the values of smear in both the example 3 and example 6 are below 0.2 which is a target value. On the other hand, in the case of the comparative example 1, the value of smear is larger than 0.3 even after two minutes and below 0.2 after four minutes. These facts indicate that the lower the value of smear, the better the fixing properties. It was confirmed that by using the fixer having an affinity for the carrier solution of the liquid developer, the time period during which a good fixing state is obtained can be reduced, whereby the fixing speed can be increased.

As described above, according to the present embodiment 1, as the softener, which is contained in the fixer 93 applied by the fixing apparatus 90 for fixing a toner image onto a transfer paper P which is a recording body, the toner image being formed by using the liquid developer constituted by a toner and carrier solution, a softener having an affinity for the carrier solution is used. Accordingly, the softener easily penetrates into the carrier solution, and the time period during which the softener reaches resin particles of the toner can be reduced, whereby the time period for softening the toner can be reduced and the fixing speed can be increased.

Further, the fixing apparatus 90 is provided on the downstream side of the secondary transfer nip, and the fixer 93 containing the softener is fed to the transfer paper P to which the toner image was transferred. Accordingly, the fixing apparatus 90 is provided on the upstream side of the secondary transfer nip, and the fixing time period becomes shorter, compared to the case in which the fixer is fed to the transfer paper P before the toner image is transferred thereto.

Furthermore, as with the fixer 93, by feeding, to the toner image, the softener as the fixing agent which is constituted by a softener and a diluting agent for diluting the softener or a dispersing agent for dispersing the softener, an appropriate amount of the softener can be fed uniformly.

Moreover, by using nonvolatile softener as the softener, reduction of the density caused by evaporation of the softener is prevented, thus the density of the softener inside the fixer 93 can be kept uniform. Further, since the softener does not evaporate, the advantages are that the fixer 93 has a good keeping quality, that air pollution is not caused, and that substantially no odor is caused. It should be noted that, since the fixer 93 containing the softener does not evaporate, the softener can be securely brought into contact with the toner, and thereby the toner can be softened more effectively, compared to the conventional fixer which vaporizes quickly.

Since the diluting solution as a diluting agent (or dispersing solution as a dispersing agent) has an affinity for the carrier solution, the diluting solution (or dispersing solution) can be mixed easily with the carrier solution without causing the fixer to be repelled by the carrier solution. Accordingly, the time period during which the softener inside the fixer 93 reaches the resin particles of the toner inside the liquid developer can be reduced, thus the fixing speed can be increased.

By using a nonvolatile diluting solution as the diluting solution which is a diluting agent (or dispersing solution as a dispersing agent), increase of the density caused by evaporation of the diluting solution (or dispersing solution) is prevented, thus the density of the softener inside the fixer 93 can be kept uniform. Further, since the diluting solution does not evaporate, the advantages are that the fixer 93 has a good keeping quality, that air pollution is not caused, and that substantially no odor is caused.

As the fixing agent, by using the fixer 93 in which the diluting agent or dispersing agent is liquid, it can be fed easily by using a pipe or pump. Also, the liquid fixer is very useful because it does not scatter like powder. Furthermore, it is easy to restrict the quantity thereof when forming a thin film or the like. Compared to a powder fixer, the softener can easily come into contact with the resin particles forming the toner, thus the fixing speed can be increased.

Moreover, as the softener contained in the fixer 93, liquid softener is used, whereby it easily penetrates into the carrier solution, while solid or gelled softener does not penetrate into the carrier solution easily, thus the liquid softener can be quickly brought into contact with the toner and the fixing speed can be increased.

By using, as the diluting solution (or dispersing solution) of the fixer 93, a substance, which is same as the carrier solution of the liquid developer, the softener inside the fixer 93 can promptly contact with and penetrate into the toner because of the good affinity between the fixer 93 and the carrier solution. Accordingly, the fixing speed can be increased.

Also, silicone oil can be used as the diluting solution. In silicone oil, the bond angle between atoms is large, the space between the atoms is also large, the outside of spiral molecules is covered with a methyl group, and the attracting force between the molecules is week, thus the surface tension is low. For this reason, when the silicone oil is applied to a mass of resin, good wetting properties are obtained and the fixer 93 can be applied uniformly and thinly.

Moreover, the fixing apparatus 90 is provided as the fixing means of the printer 100, whereby an image forming apparatus which can increase the fixing speed can be obtained.

As in Modification 1, by using the gelled fixer, the resin particles and the like are not moved, thus the softener can be adhered and fixed onto the resin without distorting the image.

2^{nd} Embodiment

In the embodiment 1 described above, the fixing apparatus 90 is provided on the downstream side of the secondary transfer nip, and the fixer 93 containing the softener is fed to the transfer paper P to which the toner image was transferred. The position of the fixing apparatus 90 feeding the fixer to the toner image is not limited to the position described above.

Hereinafter, an embodiment 2 is described in which the fixing apparatus 90 is disposed on the upstream side of the secondary transfer nip in the conveying direction of the transfer paper P. The configuration of the embodiment 2 is same as that of the above-described embodiment 1 except for the position for setting the fixing apparatus 90, thus the explanations for the same configurations are omitted and only the differences between the embodiments are described.

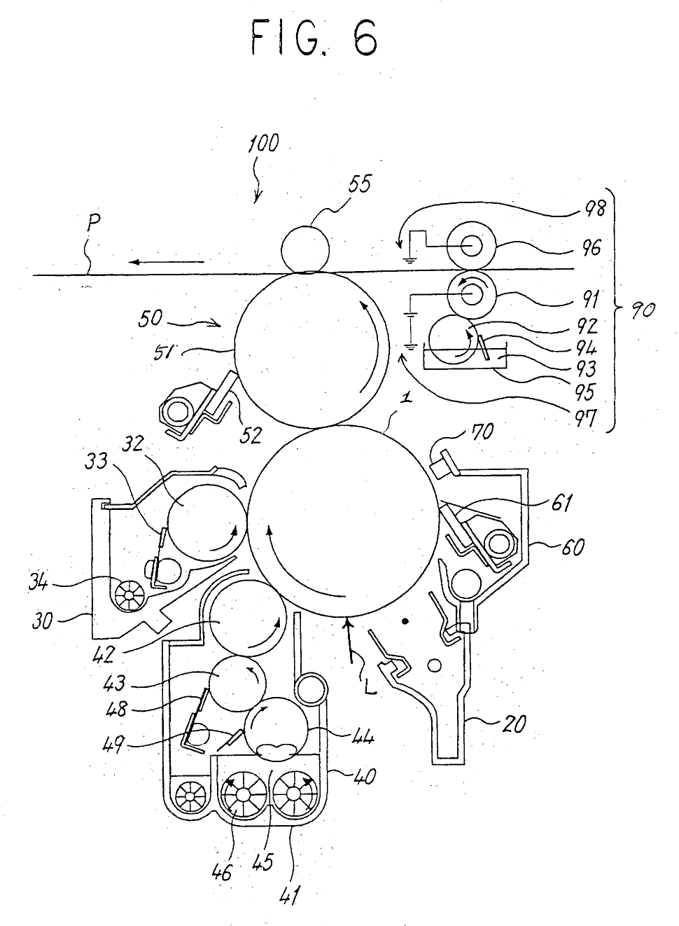

FIG. 6 is a figure showing a schematic configuration of a substantial part of the printer 100 which is an image forming apparatus according to the present embodiment 2. As shown in FIG. 6, in the printer 100 of the present embodiment 2, the fixing apparatus 90 is disposed on the upstream side of the secondary transfer section in the moving direction on the surface of the transfer paper P. This fixing apparatus 90 comprises the fixing roller 91, which is fixer application means disposed so as to abut on the surface of the transfer paper P via the fixer. The fixing apparatus 90 is configured in a movable manner by the unshown driving mechanism so that the fixing roller 91 can approach or separate from the surface of the transfer paper P. The fixer 93 is stored in the fixer tank 95 of the fixing apparatus 90, and the fixing apparatus 90 is disposed in a state in which the feed roller 92 for feeding the fixer 93 to the fixing roller 91 is immersed in the fixer 93. It should be noted that, as the feed roller 92, the one which is same as that in the above embodiment 1 can be used.

In the configuration in which the fixer 93 is applied to the transfer paper P which has passed through the secondary transfer nip, as in the above embodiment 1, the fixing roller 91 adhered with liquid is brought into contact with an unfixed toner image, whereby the toner image on the transfer paper P may be distorted. The reason that the image is distorted by the fixing roller 91 contacting with the toner image is as follows.

For example, if the moving speed of the transfer paper P is slow compared to the time required for softening the toner (in the case of roller application, the longer the time period during which the roller and the transfer material are in contact with each other), viscosity of the toner increases, the force of toners adhering to each other and the force of the toners adhering to the transfer paper P increase, whereby the toner image is not distorted easily. However, if the moving speed of the transfer paper P is faster compared to the time required for softening the toner (in the case of roller application, the shorter the time period during which the roller and the transfer material are in contact with each other), the toner image may adhered to the fixer 93 adhering to the fixing roller 91, and then separate from the transfer paper P. Accordingly, the image is distorted easily on the transfer paper P. Further, in the case of spray application such as an inkjet using the liquid fixer 93, the toner may be moved by the force of the fixer.

These problems are sever in the case of, particularly, a dry toner. Adhering power of the toner in the liquid developer against the paper is stronger than that of the dry toner.

In the present embodiment 2, the fixing apparatus 90 is provided on the upstream side of the secondary transfer nip, and the fixer 93 is applied to the transfer paper to which a resin layer is not yet adhered. Accordingly, even in the case in which the fixing roller 91 contacting with the resin layer is used as the fixer feeding means for feeding the fixer 93 onto the transfer paper P, the resin layer such as a toner image supported on the transfer paper P is not distorted. Therefore, in addition to the advantage obtained when providing the fixing apparatus 90 on the downstream side of the secondary transfer nip, there is an advantage that an application method such as contact application, spray application and the like can be selected regardless of whether the toner image is distorted or not. Moreover, by using nonvolatile softener, nonvolatile diluting agent, and nonvolatile fixer 93, the toner can be softened/swollen without allowing these liquids to vaporize even when applied onto the transfer paper P beforehand. As described above, in the present embodiment 2, the softener and the fixer containing the softener are adhered to a recording medium beforehand, and thereafter a resin to be fixed is placed on the recording medium, an image is not damaged by the application of the fixer 93. Furthermore, the toner is not supported on the transfer paper P when applying the fixer 93, thus, even when the fixing roller 91 as the application means contacts with the transfer paper P, offset cased by the toner does not occur. Furthermore, if volatile fixer is applied onto the transfer paper P before secondary transfer is performed, the fixer may evaporate and desired fixing properties may not be obtained. However, by using the nonvolatile fixer 93, the impact on the fixing properties can be reduced even if the fixer is applied beforehand. Moreover, by using the nonvolatile fixer, the paper can be prevented from being wrinkled.

3^{rd} Embodiment

In the above embodiment 1 and the embodiment 2, the fixer 93 is fed onto the transfer paper P which is a recording body, and the toner image and the softener are brought into contact with each other. Feeding the fixer to the toner image is not only performed on the transfer paper P but also performed on an image supporting body before transferring it to the transfer paper P.

Hereinafter, the present embodiment 3 is described in which the fixer is fed to the toner image formed on the photoconductor drum 1, which is the image supporting body. The configuration of the embodiment 3 is same as that of the above-described embodiment 1 except for the position for setting the fixing apparatus 90, thus the explanations for the same configurations are omitted and only the differences between the embodiments are described.

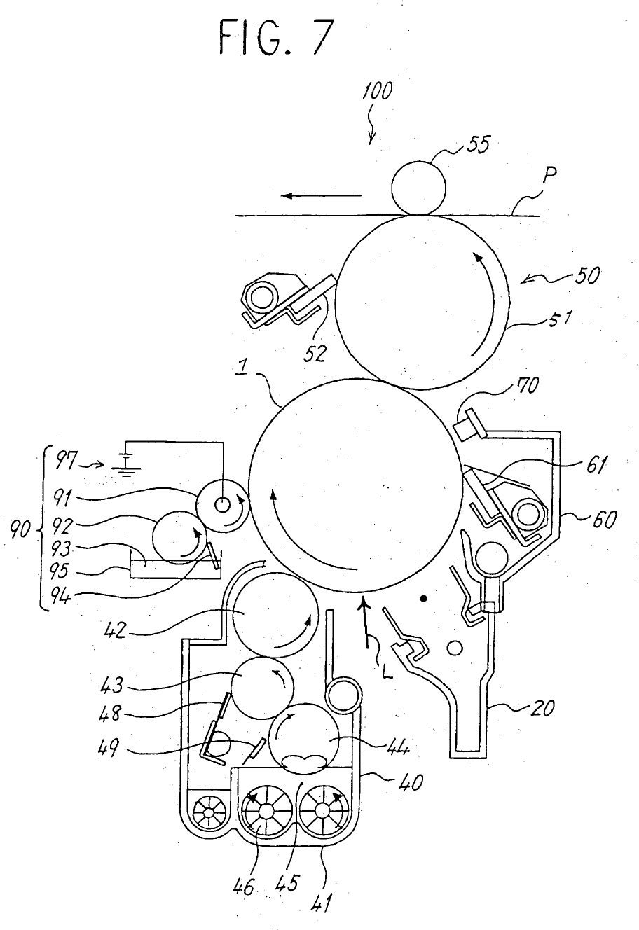

FIG. 7 is a figure showing a schematic configuration of a substantial part of the printer 100 which is an image forming apparatus according to the embodiment 3. As shown in the figure, in the printer 100 of the present embodiment 3, there is disposed, in the moving direction on the surface of the photoconductor drum 1, the fixing apparatus 90 on the downstream side of a development region which is a position facing the development apparatus 40. This fixing apparatus 90 comprises the fixing roller 91, which is fixer application means disposed so as to abut on the surface of the photoconductor drum 1 via the liquid developer and the fixer. The fixer 93, which is a liquid fixing agent, is stored in the fixer tank 95 of the fixing apparatus 90, and the fixing apparatus 90 is disposed in a state in which the feed roller 92 for feeding the fixer to the fixing roller 91 is immersed in the fixer 93. It should be noted that, as the feed roller 92, the one which is same as that in the above embodiment 1 can be used.

As in the above embodiment 2, when using the fixing roller 91 as the fixer feeding means for feeding the fixer 93 to the toner on the photoconductor drum 1, the toner image supported on the photoconductor drum 1 may be distorted. Therefore, in the present embodiment 3, the fixing roller 91 is used in which a base body configured with a conductive material is covered with an insulating layer or high-resistance layer, and the fixing roller power source 97 as electric field forming means is connected to this fixing roller 91. Specifically, for example, the one in which a conductive rubber layer is formed on a stainless cored bar and the surface of the conductive rubber layer is covered with an insulating PFA tube can be used. By this configuration, between the fixing roller 91 and the photoconductor drum 1, an electric field is formed in a direction of pressing the toner against the photoconductor drum 1. By forming such an electric field, a restraint force of the toner against the photoconductor drum 1 can be increased, the toner being formed on the photoconductor drum 1 in the fixer feeding position. Accordingly, the fixer 93 can be fed to the toner without distorting the toner image supported on the photoconductor drum 1.

At the position where the photoconductor drum 1 and the fixing roller 91 face each other (agent feeding position), the fixer 93 on the fixing roller 91 is mixed with the carrier solution covering the toner, and is then applied to the toner. As the photoconductor drum 1 moves the surface thereof, the toner applied with the fixer 93 is conveyed to the primary transfer nip formed by the photoconductor drum 1 and the intermediate transfer roller 51. Until conveyed to the primary transfer nip, the resin component of the toner is softened by the softener of the fixer 93 and thereby generates viscosity. An excess portion of the fixer 93 impregnated in the toner at the time of swelling is ejected to the surface, and toner particles adhere to each other, whereby the toner is changed into a film-like substance.

As the photoconductor drum 1 moves the surface thereof, the toner which has changed into a film-like substance is pressed against the surface of the intermediate transfer roller 51 at the primary transfer nip, and thereby is transferred and fixed onto the transfer paper P by the viscosity of the toner. At the same time, transfer bias may be applied. Since the toner particles are substantially in the form of a film, the toner hardly scatters even when excess transfer bias is generated. Since the fixer vaporizes more easily on the photoconductor drum 1 than on the transfer paper P, nonvolatile fixer is particularly effective.

As described above, according to the present embodiment 3, the fixer 93 containing the softener is applied to the toner image on the photoconductor drum 1, thus adhesive transfer of the toner to the intermediate transfer roller 51 or transfer paper P is also possible. Furthermore, since the toner hardly scatters, the toner can be prevented from scattering. Moreover, the charge of the toner is large on the photoconductor drum 1, thus the toner image is not distorted easily.

4^{th} Embodiment

In the above embodiment 3, regarding the configuration of feeding the fixer 93 to the toner image on the image supporting body, a case in which the image supporting body is the photoconductor drum 1 was explained. The photoconductor drum 1 is not the only configuration for feeding the fixer 93 to the toner image. Hereinafter, an embodiment 4 is described in which the intermediate transfer roller 51 is used as the image supporting body, the surface of which is formed with a toner image fed with the fixer 93. The configuration of the embodiment 4 is same as that of the above-described embodiment 1 except for the position for setting the fixing apparatus 90, thus the explanations for the same configurations are omitted and only the differences between the embodiments are described.

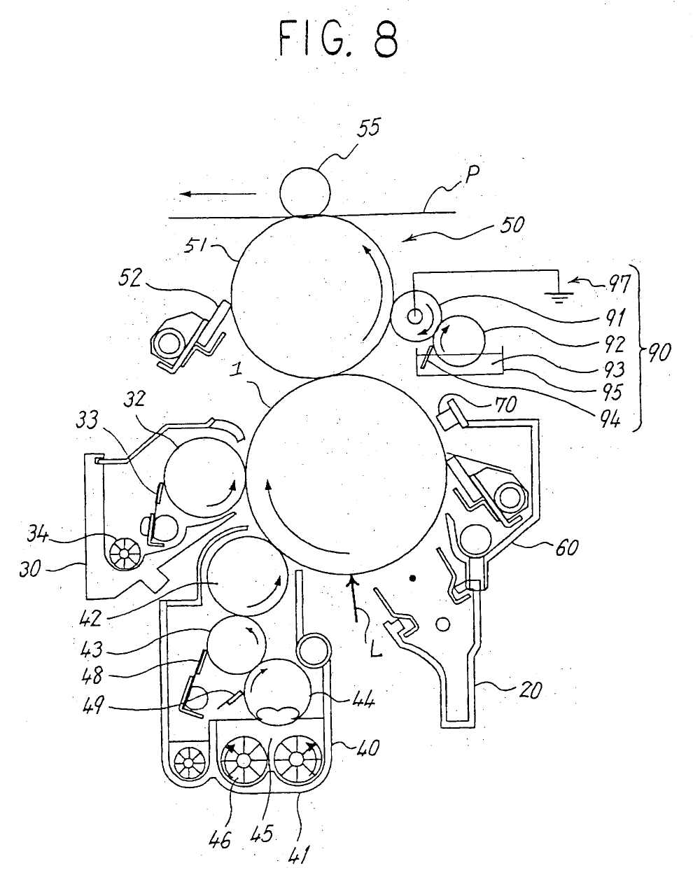

FIG. 8 is a figure showing a schematic configuration of a substantial part of the printer 100 which is an image forming apparatus according to the embodiment 4. As shown in FIG. 8, in the printer 100 of the present embodiment 4, there is disposed, in the moving direction on the surface of the intermediate transfer roller 51, the fixing apparatus 90 on the downstream side of the primary transfer nip which is a position facing the photoconductor drum 1, and on the upstream side of the secondary transfer nip. This fixing apparatus 90 comprises the fixing roller 91, which is fixer application means disposed so as to abut on the surface of the intermediate transfer roller 51 via the liquid developer and fixer. The fixing apparatus 90 is configured in a movable manner by an unshown driving mechanism so that the fixing roller 91 can approach or separate from the surface of the intermediate transfer roller 51.

The fixer 93 is stored in the fixer tank 95 of the fixing apparatus 90, and the fixing apparatus 90 is disposed in a state in which the feed roller 92 for feeding the fixer to the fixing roller 91 is immersed in the fixer 93. It should be noted that, as the feed roller 92, the one which is same as that in the above embodiment 1 can be used.

As in the present embodiment 4, when using the fixing roller 91 as the fixer feeding means for feeding the fixer 93 to the toner on the intermediate transfer roller 51, the toner image supported on the intermediate transfer roller 51 may be distorted. Therefore, in the present embodiment 4, the fixing roller 91 is used in which a base body configured with a conductive material is covered with an insulating layer or high-resistance layer, and the fixing roller power source 97 as electric field forming means is connected to this fixing roller 91. It should be noted that the fixing roller power source 97 may be connected to the ground as shown in FIG. 8. Specifically, for example, the one in which a conductive rubber layer is formed on a stainless cored bar and the surface of the conductive rubber is covered with an insulating PFA tube can be used. By this configuration, between the fixing roller 91 and the intermediate transfer roller 51, an electric field is formed in a direction of pressing the toner against the intermediate transfer roller 51. By forming such an electric field, a restraint force of the toner against the intermediate transfer roller 51 can be increased, the toner being positioned on the intermediate transfer roller 51 in the fixer feeding position. Accordingly, the fixer 93 can be fed to the toner without distorting the toner image supported on the intermediate transfer roller 51.

It should be noted that, although not shown, in the case of a color image forming apparatus in which a toner image is formed by overlapping various color toner images on the intermediate transfer roller (or belt) 51, after a toner image is formed the composite toner image is conveyed to the position facing the fixing roller 91 of the fixing apparatus 90, along with the surface movement of the intermediate transfer roller 51. The fixing apparatus 90 waits in a state in which it is separated from the intermediate transfer roller 51, until the composite toner image is conveyed. Then, immediate before an edge of the composite toner image reaches the position facing the fixing roller 91, the fixing apparatus 90 moves to the position where the fixing roller 91 is brought close to the surface of the intermediate transfer roller 51 by the driving mechanism. Accordingly, the fixer 93 on the fixing roller 91 is fed to the surface of the intermediate transfer roller 51.

Thereafter, the resin component of the toner is softened by the fixer 93 before the secondary transfer nip is reached, whereby viscosity is generated in the toner. An excess portion of the fixer 93 impregnated in the toner at the time of swelling is ejected to the surface, and toner particles adhere to each other, whereby the toner is changed into a film-like substance. As the intermediate transfer roller 51 moves the surface thereof, the toner which has changed into a film-like substance is pressed against the surface of the transfer paper P at the secondary transfer nip, and thereby is transferred and fixed onto the transfer paper P by the viscosity of the toner. At the same time, transfer bias may be applied. Since the toner particles are substantially in the form of a film, the toner hardly scatters even when excess transfer bias is generated. As with the photoconductor drum 1 of the embodiment 3, since the fixer 93 vaporizes more easily on the intermediate transfer roller 51 than on the transfer paper P, nonvolatile fixer is particularly effective.

As described above, according to the present embodiment 4, the fixer 93 containing the softener is applied to the toner image on the intermediate transfer roller 51, thus adhesive transfer of the toner to the transfer paper P is also possible. Furthermore, since the toner hardly scatters, the toner can be prevented from scattering. Moreover, the charge of the toner is large on the intermediate transfer roller 51, the toner image is not distorted easily.

As described above, according to each of the embodiments 1 through 4, there is an excellent effect in which the time required for softening the toner can be reduced and thereby the fixing speed can be increased.

5^{th} Embodiment

Hereinafter, an embodiment 5 is explained in which the present invention is applied to an image forming apparatus of electrophotographic system using the liquid developer as with the above-described embodiments.

It should be noted that a large proportion of the explanation of the above embodiment 1 is substantially applied in the present embodiment 5, thus repetition of explanation is omitted herein. Therefore, only the particular differences between the present embodiment 5 and the above embodiment 1 are described hereinafter.

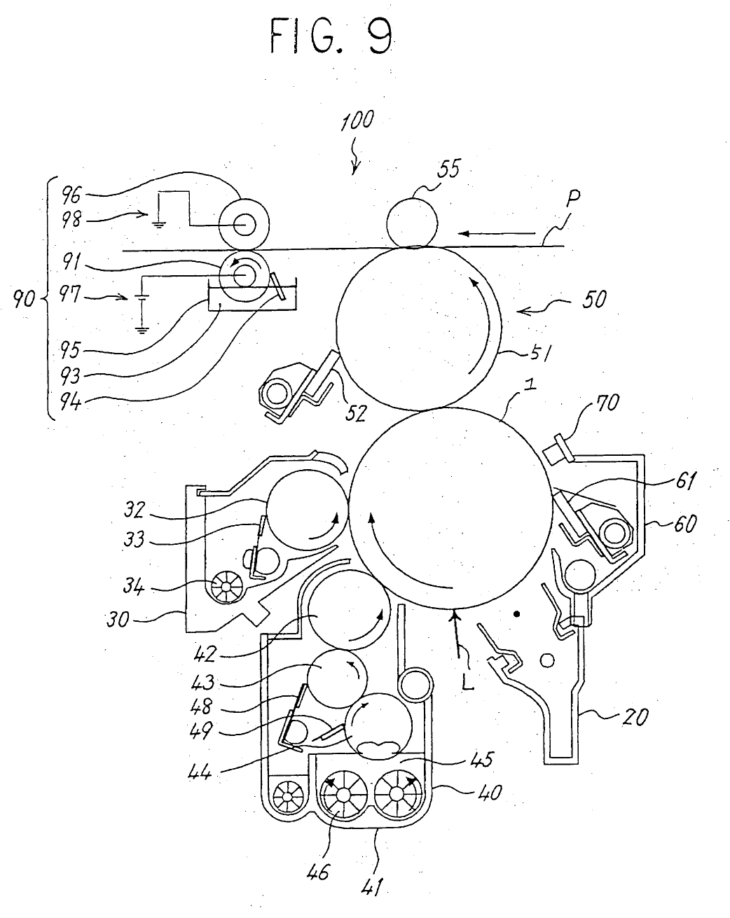

First of all, a printer 100, which is the image forming apparatus of the present embodiment 5, is shown in FIG. 9. As shown in the figure, in this printer 100 the fixing apparatus 90 is disposed on the downstream side of the secondary transfer section in the moving direction on the surface of the transfer paper P. This fixing apparatus 90 comprises the fixer tank 95 for storing the fixer 93, the fixing roller 91 which is the fixer feed roller of the feeding means of the fixer 93, and a pressurizing roller 96 which functions as pressurizing means facing the fixing roller 91 so as to hold the transfer paper P, which is a recording body, therebetween. A part of the fixing roller 91 is immersed in the fixer 93, and thereafter excess liquid is scraped of by means of a metering blade 94, whereby a predetermined thickness of a thin layer is formed and the fixer 93 is supported on the surface of the fixing roller 91 at an amount required for fixing toner. It should be noted that this printer 100 is completely the same as the one shown in FIG. 1 except for this configuration of the fixing apparatus 90.

As the range of the viscosity and the ratio of the solid toner of the liquid developer 45 used in the development apparatus 40 of the present embodiment 5, for example, the viscosity is 50 [mPa·s] through 10000 [mPa·s] and the ratio of the solid toner is 5[%] through 40[%] is used. As the carrier solution, the one with high insulating properties such as silicone oil, normal paraffin, Isopar M (trademark of Exxon Corporation), vegetable oil, mineral oil, or the like is used. The volatility or nonvolatility can be selected according to the purpose.

Moreover, in the present embodiment 5, the thickness of the developer thin layer formed on the surface of the developing roller 42 is set so that the pigment content in the toner which is supported per 1 [cm²] of the surface of the developing roller 42 becomes at least 3 [μg] and 60 [μg] or less. In order to realize this thickness, the fixer is applied so that the thickness of the developer thin layer becomes 3 [μm] through 12 [μm]. If the developer thin layer has a thickness that reduces the pigment content in the toner to less than 3 [μg], the toner being supported per 1 [cm²] of the surface of the developing roller 42, a sufficient amount of the pigment is not moved to a latent image section formed on the photoconductor 1, whereby the image density on the image section maybe reduced. Moreover, if the developer thin layer has a thickness that increases the pigment content in the toner to more than 60 [μg], the toner being supported per 1 [cm²] of the surface of the developing roller 42, excess toner remaining on the ground section after development increases, whereby the excess toner may not be removed completely by the photoconductor sweeping apparatus 30 described hereinafter.

It should be noted that the surface hardness of the conductive elastic layer of the developing roller 42 is preferably 50 [degrees] or less as measured by JIS-A hardness in order to perform nipping efficiently with the photoconductor drum 1. The material of the conductive elastic material is not limited to urethane rubber, and thus can be a conductive material which does not swell or dissolve in the carrier solution/developer. It should be noted that, if the surface of the developing roller 42 has conductivity and is configured by a material which does not swell or dissolve in the carrier solution/developer, and the carrier solution/developer does not come into contact with an inner layer of the developing roller 42, then the material of the elastic layer as the inner layer may not have any restriction in the conductivity/swelling and dissolving, and thus only needs to have elasticity. Therefore, if the elastic layer is provided as the inner layer, and this elastic layer does not have conductivity, developing bias needs to be applied from the surface of the developing roller 42, not from an axis of the developing roller 42.

Furthermore, in the present embodiment 5, when the developing roller 42 and the sweep roller 32 are caused to abut against the photoconductor drum 1 with appropriate pressure, the elastic layer of each roller elastically deforms to form a developing nip and a removal nip. Particularly by forming the developing nip, it is possible to secure fixed developing time for moving the toner inside the liquid developer 45 to the photoconductor drum 1 by means of the developing electric field of the developing region and adhering the toner. Also, by adjusting the abutment pressure, the nip width, which is the size in the moving direction on the surface in each nip section, can be adjusted. Each nip width is set to be at least the product of the linear speed of each roller and a developing time constant. Here, the developing time constant is time required for the developed amount is saturated, and is obtained by dividing the minimum required nip width by processing speed. For example, if the minimum required nip width is 5 [mm] and the processing speed is 500 [mm/s], the developing time constant is 10 [msec].

After development is performed by the developing roller 42, the liquid developer 45 is recovered by the intermediate roller 43 in order to prevent ghost to occur, and then removed by the developing cleaning blade 48. The liquid developer, which is removed from the photoconductor drum 1 by the sweep roller 32, is removed by the sweep cleaning blade 33 in order to maintain the sweeping performance. These liquid developers are collected into an adjusting tank, which is not shown. The density is adjusted in the adjusting tank, and thereafter the developers are sent into the development apparatus 40 again. The adjusting tank has stirring means, density detecting means, and liquid amount detecting means, wherein the density and the liquid amount are detected in a state in which the density in the tank is made uniform, and then the density is adjusted by replenishing new liquid developer and carrier. From that moment, the amount of the liquid developer fed into the development apparatus 40 is set so as to be slightly larger than the used amount of the liquid developer, and the spilled amount of the liquid developer is brought back to the adjusting tank, whereby the liquid developer constantly circulates.

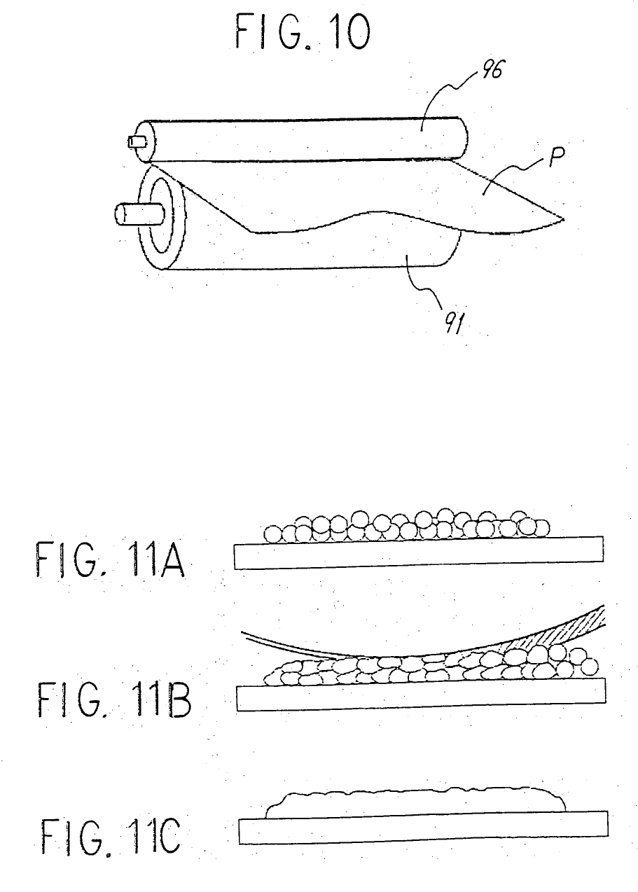

FIG. 10 shows a state in which a recording body passes through the fixing apparatus 90 of the present embodiment 5. As shown in the figure, the pressurizing roller 96 is brought into contact with the fixing roller 91 such that the transfer paper P on which an unfixed toner image is placed is conveyed therebetween, whereby a fixing nip is formed. The fixing nip is a softener feeding position at which the fixer 93 containing the softener is fed to the toner image on the transfer paper P by the fixing roller 91. Since the fixer 93 is fed to the pressurized nip, the resin of the softened toner is crushed so that the smoothness of the surface is improved, and the smoothness of the surface of the fixed image is also improved after hardening the image, whereby even when rubbing the fixed image, it is not scraped off, thus the quality of the fixed image can be maintained.

IT should be noted that, as with this fixing apparatus 90, if the nips are pressurized when feeding the fixer to the unfixed image on the transfer paper P, which is the recording medium, the toner moves to the fixing roller 91 which is a fixer feed roller, whereby the image is distorted, i.e. offset is worsened compared to the case in which the nips are not pressurized. In order to deal with this problem, the fixing apparatus 90 comprises the electric field forming means for forming an electric field in the direction in which the toner for forming an unfixed toner image is directed toward the transfer paper P side by means of the fixing nip which is the softener feeding position.

Specifically, as the electric field forming means for generating an electric field in the direction in which the toner is directed toward the transfer paper P side by means of the fixing nip which is the softener feeding position, the fixing roller power source 97 and pressurizing roller power source 98 are connected to the fixing roller 91 and pressurizing roller 96. It should be noted that one of the fixing roller power source 97 and pressurizing roller power source 98 may be connected to the ground, as shown in FIG. 9. A fixing electric field for pressing the toner particles against the transfer paper P is formed by electric field application means, and thereafter, by the fixing roller 91, the fixer 93 is fed to fix the toner in a state in which the toner particles are dissolved/swollen. In this manner, the binding between the transfer paper P and the toner particles is enhanced beforehand by the fixing electric field, thus flow of the toner particles caused by feeding the fixer 93 can be prevented and thereby image distortion can be prevented. Furthermore, by applying pressure, the occurrence of offset which may be worsened can be prevented.

FIGS. 11A through 11C are figures showing temporal changes of the fixer 93 and the toner when the fixer 93 is fed to the toner. FIG. 11A shows a state in which a substance containing a resin is placed on a member to which the resin is fixed, and FIG. 11B shows a state in which the fixer 93 is applied to the resin. The resin is softened by the fixer 93 to have viscosity, the fixer 93 is then ejected from the resin by an action of the pressure between the fixing roller 91 and pressurizing roller 96 and is impregnated into the transfer paper P, whereby resins configuring the toner are bonded with each other. FIG. 11C shows a state in which the resins are bonded and fixed.

It should be noted that when excess amount of softener is fed, the softener may not be fixed after softened, thus the viscosity still remains in the softener for a period of time even after the fixer is fed. Therefore, the problem for high-speed responsiveness is the speed of diffusion/penetration in which a bonding step is considered to be caused by diffusing the fixer into the resin or penetrating the fixer into the recording medium.

It should be noted that the pressure at the fixing nip which is the fixer feeding section is required to be sufficient for deforming the softened resin, and thus is required to be approximately several tens through several hundreds [kpa]. The smoothness of the surface of the fixing roller 91 is preferably good, because the impacts on the surface can be considered to occur at the time of pressurizing. For example, the surface roughness is preferably 2 to 3 [μm] or less in the ten point height of roughness profile Rz.

Moreover, there is an advantage that the speed of penetration of the fixer 93 penetrating the transfer paper P increases under pressure, whereby a high response is possible. Generally, as an equation expressing the speed of penetration of liquid in a capillary phenomenon, there is Olsson-Pihl equation as shown below in the following equation (1), and it is known that the speed of penetration increases if the pressure is high.

$$l = \sqrt{\frac{2 r γcos θ + {pr}^{2}}{4 η}} t \qquad Eq . ( 1 )$$

ι [m]: depth of penetration
r [m]: capillary diameter
γ [N/m]: surface tension
θ [°]: contact angle
η [Pa·s]: viscosity
p [N/m²]: pressure

From this equation (1), it is understood that, by increasing the pressure by pressurization, the speed of penetration of liquid increases. Then, by increasing the pressure, fixing can be performed at a high processing speed of 500 [mm/s].

Moreover, in the fixing apparatus 90, at the fixing nip which is the fixer feeding section, there is generated a fixing electric field for using the fixing roller power source 97 and the pressurizing roller power source 98 to press the toner particles against the transfer paper P when feeding the fixer 93. By this fixing electric field, offset that transfers the toner to the fixing roller 91 can be prevented from occurring. The offset state changes according to the voltage to be applied. In the fixing apparatus 90, a voltage of at least 600 [V] was applied to the fixing roller power source 97 to form the electric field, whereby the offset can be prevented from occurring.

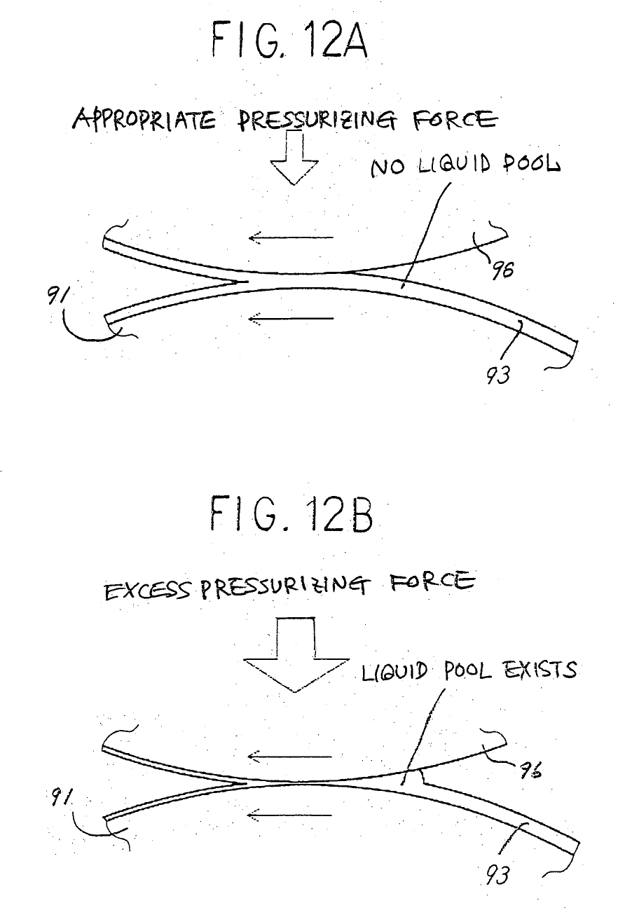

As described above, by generating the fixing electric field at the fixing nip, offset can be prevented from occurring on the fixing roller 91, but the entire liquid cannot pass between the nip if the pressure is increased excessively at the fixing nip. Hereinafter, problems in which the entire liquid cannot pass between the nip are described with reference to FIG. 12A and FIG. 12B.

FIG. 12A shows a state in which the entire fixer passes through the fixing nip, and FIG. 12B shows a state in which a part of the fixer cannot pass through.

In a state in which the applied-pressure is so high that the entire fixer cannot pass between the nip, if the fixer recording body is a continuous body, the excessively high applied-pressure is not a significant problem. However, if the recording body is discontinuous such as papers, that is, if a space exists between papers, liquid to be fed to the space between the papers is accumulated at the inlet of the fixing nip because of the excessively high applied-pressure as shown in FIG. 12A, and then the liquid adheres excessively to a leading end section of a transfer paper P which subsequently passes through, whereby an unfixed image is distorted or the fixing properties are deteriorated.

Therefore, the applied-pressure between the fixing roller 91 and the pressurizing roller 96 of the fixing apparatus 90 is set to be a pressure or lower at which the entire fixer on a fixer layer held on the fixing roller 91 can pass through, as shown in FIG. 11A. Accordingly, even when the fixing roller 91 and the pressurizing roller 96 are in contact with each other at the timing at which the transfer paper P does not pass through, the liquid is not accumulated at the inlet of the fixing nip. Therefore, even after the transfer paper P is caused to pass through subsequently, excess fixer does not adhere to a leading end of the transfer paper P. In this manner, a liquid pool is not generated even if the space between the rollers is not provided with a mechanism of causing the rollers to contact with and separate from each other, and further a problem caused by adhesion of excess fixer can be prevented.

As described above, in the fixing apparatus 90, the linear pressure between the fixing roller 91 and the pressurizing roller 96 is adjusted so that the entire fixer 93 on the fixing roller 91 can pass through the fixing nip. As a method of reducing the pressure at the fixing nip, it is effective to reduce the hardness of the elastic layers of the rollers (longitudinal elasticity constant), but there is a restriction in generating a conductivity as the electrical properties of the roller or obtaining required diametral accuracy.

According to elastohydrodynamic lubrication theory, the maximum thickness h of fluid which can pass through the nip section between two rollers is obtained by the following equation (2).
h=k×[(η³U³R³)/E²W]⁰² Eq. (2)
where k is a constant.

W [N/m]: linear pressure

η [Pa·s]: viscosity

U [m/s]: roller linear speed

R [m]: relative curvature radius

E [N/m²]: reduced modulus of longitudinal elasticity

h [m]: liquid thickness

The relative curvature radius R [m] is obtained by the following equation (3).
1/R=1/Rᵢ+1/R₂ Eq. (3)

R₁, R₂ [m]: radius of each of the two rollers

The reduced modulus of longitudinal elasticity E [N/m²] is obtained by the following equation (4).
1/E=1/2×[(1−δ₁²)/E₁+(1−δ₂²)/E₂] Eq. (4)

δ₁, δ₂: Poisson ratio of each of the two rollers

E₁, E₂ [N/m²]: modulus of longitudinal elasticity of each of the two rollers

Here, as the two rollers in the equations (2) through (4), the fixing roller 91 which is the fixer feeding means and has an elastic layer at the surface thereof, and the pressurizing roller 96 in which the pressurizing means is in the form of a cylinder are used to obtain the constant k in accordance with the fixing apparatus 90.

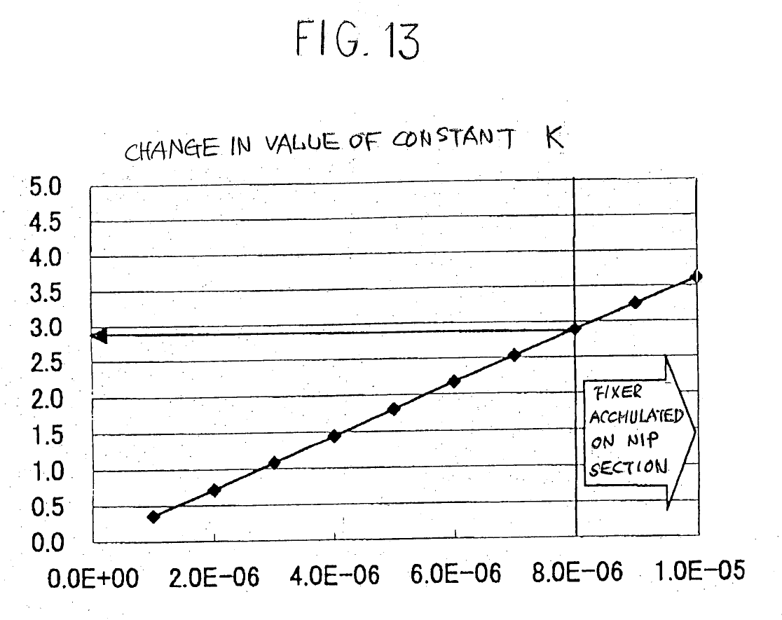

In the experiment, the application amount (thickness) of the fixer 93 on the fixing roller 91 is changed to obtain the maximum fixer thickness at which the fixer 93 is accumulated at the fixing nip. The result of the experiment is shown in FIG. 13. Using the result shown in FIG. 13, the constant kin the equation (2) is obtained. It should be noted that in the present embodiment computation is carried out based on k=2.88, k⁵−2.88⁵≅200 using the graph shown in FIG. 13.

Using the obtained value of k and the equation (2), the maximum value of the linear pressure at the fixing nip is obtained. Specifically, after determining various conditions of the fixing roller 91 and pressurizing roller 96 configuring the fixing apparatus 90, and also after determining required thickness of the fixer 93, the linear pressure W [N/m] of the pressurizing roller 96 with respect to the fixing roller 91 is set so that the conditions of the following equation (5) are satisfied.
W<200×[(η³U³R³)/E²h_{f}⁵] Eq. (5)

W [N/m]: linear pressure

η [Pa·s]: viscosity

U [m/s]: roller linear speed

R [m]: relative curvature radius

E [N/m²]: reduced modulus of longitudinal elasticity

h_{f} [m]: fixer thickness (on the fixer feed roller)

The relative curvature radius R [m] is obtained by the following equation (6).
1/R=1/R_{f}+1/Rₚ Eq. (6)

R_{f} [m]: radius of the fixer feed roller

Rₚ [m]: radius of the pressurizing roller

The reduced modulus of longitudinal elasticity E [N/m²] is obtained by the following equation (7).
1/E=1/2×[(1−δ_{f}²)/E_{f}+(1−δₚ²)/Eₚ] Eq. (7)

δ_{f}: Poisson ratio of the fixer feed roller

δₚ: Poisson ratio of the pressurizing roller

E_{f} [N/m²]: modulus of longitudinal elasticity of the fixer feed roller

Eₚ [N/m²]: modulus of longitudinal elasticity of the pressurizing roller

It should be noted that the fixing roller and the pressurizing roller move the surfaces thereof at the same linear speed, and the linear speed can be expressed in the abovementioned U [m/s].

The fixer 93 on the fixing roller 91 is measured by setting the linear pressure so that the equation (5) is satisfied, and the entire fixer 93, the amount of which has reached a predetermined amount, can pass through the fixing nip. On the other hand, it is necessary to secure sufficient fixing time at the fixing nip, thus the linear pressure may be increased as much as possible to increase the nip width. Therefore, in the fixing apparatus 90, the linear pressure is set to be approximately 60 through 80[%] of the linear pressure calculated in the above equation.

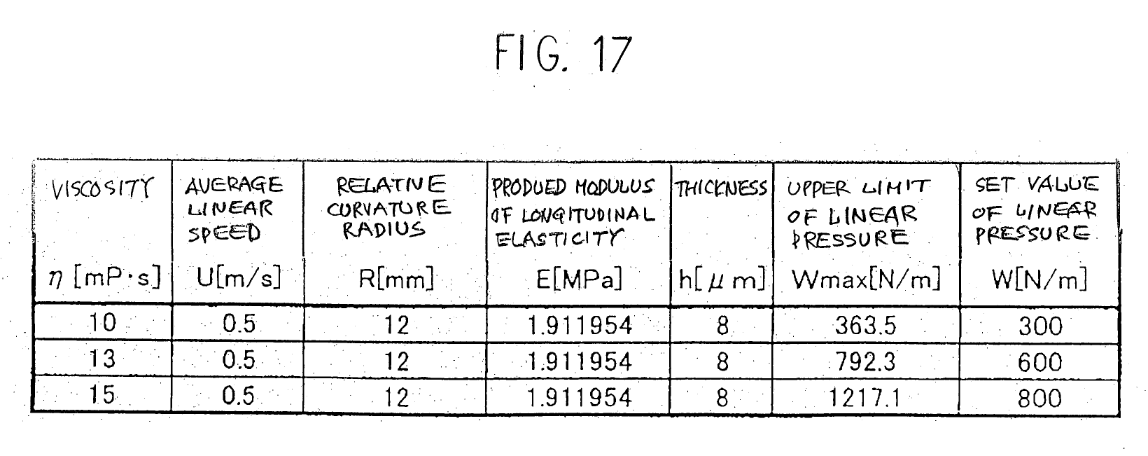

FIG. 17 shows the viscosity of the fixer which is actually used, the upper limit value of the linear pressure at that time, and the set value of the linear pressure.

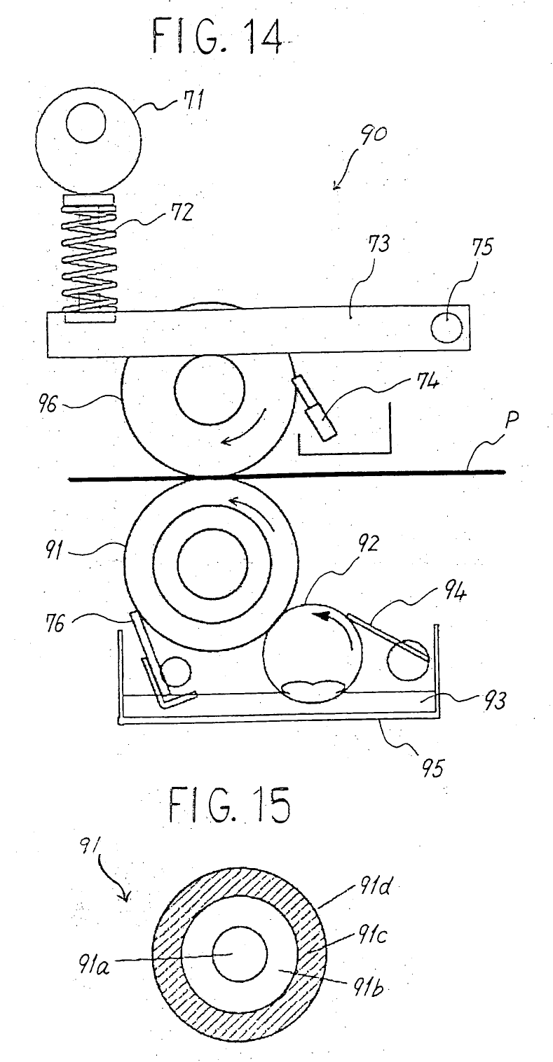

FIG. 14 shows a fixing apparatus 90A shown enlarged according to the present embodiment 5.

As shown in FIG. 14, the fixing apparatus 90 comprises a mechanism of adjusting the abutment pressure of the fixing roller 91 against the pressurizing roller 96. To describe a specific configuration, the fixing apparatus 90 comprises a pressurizing spring 72 as biasing means for causing the pressurizing roller 96 to abut against the fixing roller 91, wherein one end of the pressurizing spring 72 is connected to an eccentric cam 71, while other end is connected to one end of a pressurizing arm 73. Other end of the pressurizing arm 73 is supported by an arm rotation axis 75 to fix the position of the pressurizing arm 73. The one end of the pressurizing arm 73, which is a holding section, can change the position thereof in response to the movement of the eccentric cam 71, and can adjust the abutment pressure at the fixing nip by changing the phase of the eccentric cam 71. It should be noted that a mechanism for adjusting the abutment pressure on the fixing nip is not limited to the mechanism shown in FIG. 14, and thus can be a mechanism which can simply move one end of the holding section of the spring by means of an adjusting screw.

By providing the adjusting means as described above, appropriate abutment conditions can be set in accordance with the required thickness of the fixer 93 even when the viscosity of the fixer is changed by an environmental change or the like. Also, by previously obtaining the data of the change in viscosity caused by temperature, appropriate abutment conditions can be set in accordance with a change in temperature of the fixer 93. Specifically, temperature detecting means for the fixer 93 may be disposed in the fixing apparatus 90, appropriate contact pressure conditions may be obtained from the temperature and viscosity which are previously stored in a storage device, as well as the data of appropriate contact pressure on the basis of a detected value, and then the pressure of the fixing roller 91 against the pressurizing roller 96 may be changed by a pressure adjusting mechanism shown in FIG. 14.

The fixing roller 91 and pressurizing roller 96 are configured such that the liquid is not accumulated at the inlet of the fixing nip, by setting the pressure so that the fixer 93 supported on the surface of the fixing roller 91 can pass through the fixing nip. However, if the amount of the fixer supported on the fixing roller 91 increases or the fixer 93 is supported on the pressurizing roller 96, the amount of fixer 93 passing through the fixing nip increases, whereby a liquid pool may be formed even at the same pressure. Particularly on the pressurizing roller 96 side, there is no problem in terms of the timing at which the transfer paper P passes through the nip. However, at the timing at which the transfer paper P is not present, the fixer 93 which has passed through the fixing nip rotate while adhering to the surfaces of the fixing roller 91 and the pressurizing roller 96. Accordingly, the fixer adhered to the pressurizing roller 96 is fed directly to the fixing nip again, and the fed amount of fixer 93 at the fixing nip may increase or may be accumulated at the fixing nip without passing therethrough.

In order to deal with this problem, the fixing apparatus 90 is provided with removing means for removing the fixer 93 adhered to the surface of the fixing apparatus, as shown in FIG. 14. In the removing means, a pressurizing roller cleaning blade 74 constituted by a flexible blade is caused to abut against the surface of the removing means. By using the pressurizing roller cleaning blade 74 to remove the fixer 93 adhered onto the pressurizing roller 96, the fixer 93 adhered to the pressurizing roller 96 can be prevented from entering the fixing nip and thereby being accumulated. Moreover, the removed fixer 93 can be conveyed again to a feed path led to the fixer tank 95 so as to be reused. The removing means for the fixer adhered to the surface of the pressurizing roller is not limited to the blade-type removing means described herein, but the blade type is used in the fixing apparatus 90 because it can be wiped with, for example, a cloth or the like, reused, and has a simple mechanism.

The elasticity of the rollers is greatly involved in the conditional equations for the liquid passage according to the above-described elastohydrodynamic lubrication theory. For example, in the case in which the fixing roller 91 and the pressurizing roller 96 are metallic rollers, the upper limit of the linear pressure shown in FIG. 17 becomes approximately 0, thus it is practically difficult to keep the contact state therebetween. In the case of the same linear pressure, the thickness of the fixer 93 capable of passing through becomes 1 [μm] or less, thus it becomes difficult to apply a required amount. Therefore, in the fixing apparatus 90, the fixing roller 91 is provided with an elastic layer.

FIG. 15 is a cross-sectional view showing a schematic configuration of the fixing roller 91. As shown in this figure, the fixing roller 91 comprises, starting from the central section thereof, a fixing roller axis section 91a, a fixing roller cored bar section 91b, a fixing roller elastic layer 91c, and a fixing roller surface slipping layer 91d. Also, the fixing roller elastic layer 91c, which is the elastic layer, is provided on the outside of the fixing roller cored bar section 91b of the fixing roller 91, and the hardness of the elastic layer is set to be approximately 30 through 40 [degrees] as measured by JIS-A hardness. The elastic layer may be formed on the pressurizing roller 96 side or on both of the two rollers. Moreover, the surface of the fixing roller elastic layer 91c is provided with the fixing roller surface slipping layer 91d in order to improve the cleaning characteristic. Such a configuration is effective in improving the surface roughness of the roller. As the fixing roller surface slipping layer 91d, for example, a conductive PFA tube or the like is used.

It should be noted that in the case in which the fixing roller 91 comprises the fixing roller elastic layer 91c, it is desired that the fixing roller elastic layer 91c have conductivity in order to form an electric field for preventing the occurrence of offset. By forming the elastic layer into which a conductive substance such as carbon is mixed, value of resistance is reduced. By forming the fixing roller elastic layer 91c in this manner, the nip width of the fixing nip can be increased, and, by reducing the contact pressure inside at the nip, the fixer 93 can be secured at an amount sufficient to pass through the fixing nip.

As described above, when forming the fixing electric field for preventing the occurrence of offset, as a method of providing the electrodes of this electric field, there is a technique of bringing an electrode into contact with the surface, and a technique of applying voltage from the cored bar section by means of a rotary contact-type electrode terminal.

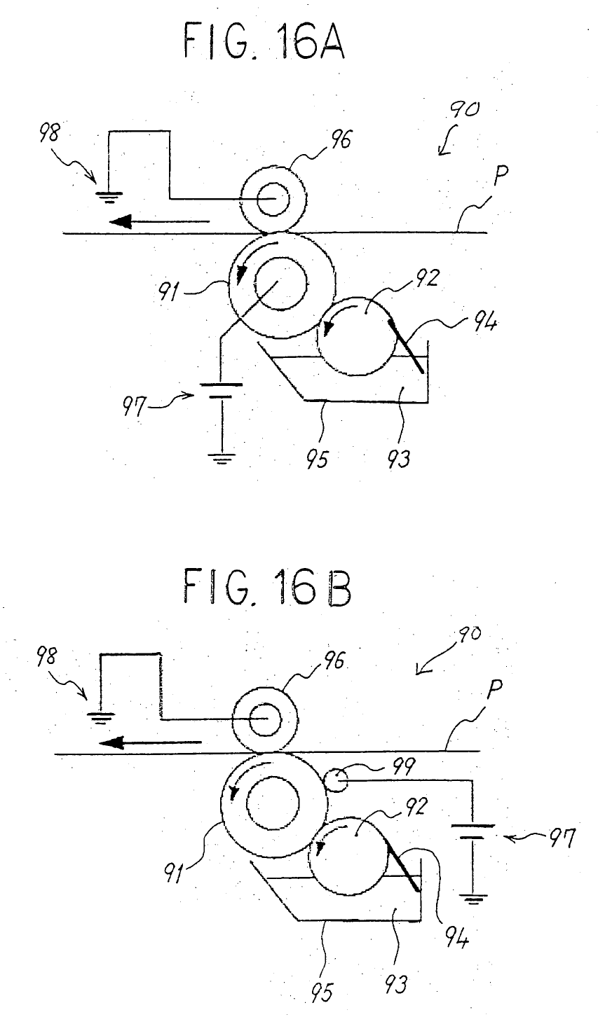

In the technique shown in FIG. 16B, as long as the surface of the fixing roller 91 has a conductive layer, other layers may or may not be insulating, but the electric field formed between the fixing roller 91 and pressurizing roller 96 may be unstable because of the contact state between the surface of the fixing roller 91 and a fixing electrode 99 and because of irregularity of the surface resistance. Moreover, since the fixer 93 is supported on the surface of the fixing roller 91 beforehand, the electrode is placed through this surface. Therefore, the electrode needs to be brought into contact with the surface without generating a liquid pool, thus placement of the electrode is difficult.

Therefore, in the fixing apparatus 90, a technique of applying voltage from the cored bar section shown in FIG. 16A by means of a rotary contact-type electrode terminal. Therefore, the electrode is provided from the cored bar section. If the fixing roller 91 has the elastic layer, it is necessary to provide a conductive elastic layer so that a relatively stable electric field can be formed, but even if the surface of the fixing roller 91 has a liquid layer, the electric field is hardly affected by the liquid layer.

In the fixing apparatus 90 of the present embodiment 5, when the electric field for preventing the occurrence of offset is formed between fixing roller 91 and the pressurizing roller 96, the effect of the electric field may fluctuate according to the length of the transfer paper P in the axial direction. If the transfer paper P is smaller than the width of the fixing roller 91 and pressurizing roller 96, even if the electric field is formed between the rollers the electric current flows the areas at both ends of the rollers where the transfer paper P is not present instead of flowing through the high-resistance transfer paper P, whereby the offset cannot be prevented from occurring. If the width of the transfer paper P is larger than or same as that of each roller, the areas at the both ends without the passing transfer paper P where the rollers contacting with each other are small, and the effect of these areas is small. Therefore, if only one size is enough for the width direction of the passing transfer paper P, the length of the fixing roller 91 and of the pressurizing roller 96 may be set to be the same as or shorter than the length of the transfer paper P.

However, if the width direction of the transfer paper P is large but not fixed, it is difficult to prevent the occurrence of offset by using a particularly small-sized transfer paper P.

Therefore, in the fixing apparatus 90, the value of resistance between the fixing roller 91 and pressurizing roller 96 without the transfer paper P therebetween is set larger than the value of resistance at the nip of the transfer paper P. By performing such setting, the difference between the resistance obtained when passing the transfer paper P through the nip and the resistance without the transfer paper P can be reduced. Therefore, even when the width of the transfer paper P is small, an offset electric field can be caused to function. The conductivity of the elastic layer of the roller is adjusted so that the resistance value of the transfer paper P is several hundreds [kΩ] under the nip conditions of the fixing apparatus 90, although it changes according to the moisture contained in the transfer paper, and the resistance value of between the rollers without the transfer paper P is over one thousand [kΩ]. When adjusting the conductivity on the basis of the resistance value of the elastic layer of the fixing roller 91, the volume resistivity of the elastic layer is approximately 1.0×10⁵ [Ω·cm].

The fixing roller 91 and pressurizing roller 96 are configured such that the liquid is not accumulated at the inlet of the fixing nip, by setting the pressure so that the fixer 93 supported on the surface of the fixing roller 91 can pass through the fixing nip. However, if the amount of the fixer 93 supported on the fixing roller 91 increases or the fixer is supported on the pressurizing roller 96, the amount of fixer 93 passing through the fixing nip increases, whereby a liquid pool may be formed even at the same pressure. Therefore, the fixing apparatus 90 comprises an application apparatus for stably feeing a fixed amount of fixer 93 to the fixing roller 91. The application apparatus comprises an engraved roller the surface of which is patterned with uniform grooves in order to obtain a stable application amount, wherein the fixer 93 is measured by the volume of the grooves and fed to the fixing roller 91. FIG. 14 shows an example of this configuration, wherein the engraved roller 92 contacts with the fixing roller 91 such that the metering blade 94 as a doctor blade is caused to abut against the engraved roller 92 immersed in the fixer 93, the amount spilled over the grooves is removed to measure the liquid amount, and then the measured liquid is fed onto the fixing roller 91. At the contact section, the rollers rotate such that the moving direction on the surface of the engraved roller 92 is reversed with respect to the moving direction on the surface of the fixing roller 91, and the rollers are driven such that the speed of movement on the surface of the engraved roller 92 is made faster than the speed of movement on the surface of the fixing roller 91. In this manner, when the fixer 93 is moved to the surface of the fixing roller 91, impacts of the groove pattern on the engraved roller 92 can be reduced, whereby a uniform application surface can be formed. Moreover, by adjusting the ratio between these speeds, the amount of the fixer 93 on the fixing roller 91 can be controlled.

Next, the saturated aliphatic ester, which is used as the softener contained in the fixer 93, is explained in the present embodiment 5.

Aliphatic dicarboxylic acid dialkoxy alkyl, which is the saturated aliphatic ester, is a compound expressed by a general formula, “R5 (COOR6-O—R7)2”, wherein, R5 is an alkylene group having 2 to 8 carbon atoms, R6 is an alkylene group having 2 to 4 carbon atoms, and R7 is an alkyl group having 1 to 4 carbon atoms. Examples of the aliphatic dicarboxylic acid dialkoxy alkyl include diethoxyethyl succinate, dibutokxyethyl succinate, diethoxyethyl adipate, dibutokxyethyl adipate, diethoxyethyl sebacate, and the like. Most of these components as the aliphatic dicarboxylic acid dialkoxy alkyl hardly vaporize (although depending on the number of carbon atoms). The solubility of these components in synthetic oil such as silicone oil and PAO, mineral oil, or hydrocarbon solvent is relatively low, and the solubility in water is higher than that of saturated aliphatic ester or aliphatic dicarboxylic acid ester. Therefore, in the case of using these components as the softener, there is a method of emulsifying and dispersing the components in synthetic oil such as silicone oil and PAO, mineral oil, or hydrocarbon solvent by means of a surfactant having an HLB value of approximately 1 through 5.

In the case of a fixer obtained by diluting a softener softening color particles, there are various diluting solutions. In the fixing apparatus 90, nonvolatile diluting solution is used because of its usefulness as described above, and use of most harmless water which is normally used is avoided. The reason of not using this water is because the electric resistance thereof is low. For example, when the softener is diluted using liquid having low electric resistance as with water, fixer having low electric resistance is obtained. In the fixing apparatus 90, as described above with reference to FIGS. 9 and 14, a fixing electric field for pressing the toner against the transfer paper P is formed in order to prevent a phenomenon in which color particles (toner) are adhered to the fixing roller 91 (offset) when feeding the fixer. Regarding the effect of the fixing electric field, if, for example, liquid having low resistance such as water is significantly contained in the fixer, the potential difference between the roller surface and the fixer surface becomes low because of the impacts of the electric resistance of the fixer, whereby the effects of preventing the occurrence of offset are reduced. On the other hand, in the case of a substantially insulating body, a larger effect is obtained. Therefore, the fixer 93 used in the fixing apparatus 90 desirably has high electrical insulation, is substantially insulating, and has a volume resistivity of at least 10¹³ [Ω·cm].

Examples of such liquid having high electrical insulation include silicone oil, normal paraffin, Isopar M (trademark of Exxon Corporation), vegetable oil, mineral oil and the like which are used as the carrier solution for dispersing resin particles of the liquid developer. Out of the above liquids, silicone oil is suitable as the carrier solution because the binding energy between molecules is large and the bond is hardly broken, and because the silicone oil is strong to heat, highly stable, and has high electrical insulation (volume resistivity is ×10¹⁴ through ×10¹⁶ [Ω·cm]). Therefore, silicone oil is used as the carrier solution of the liquid developer.

Moreover, as the diluting solution of the fixer, by using the same substance as the carrier solution of the liquid developer, the functions of the fixer are not damaged even if a small amount of liquid developer is mixed into the fixer. Further, as described above, the electrical insulation of the carrier solution of the liquid developer is high because of its need, thus the carrier solution is suitable to be used in the diluting solution of the fixer.

As described above, by using the fixer having an affinity for the carrier solution, the fixing speed can be increased, thus the image forming speed can be improved. Particularly, as the diluting solution of the fixer, by using the same substance as the carrier solution of the liquid developer, the charging properties and the like of the toner are not changed.

It should be noted that in the present embodiment 5 as well, the explanations of [Modification 1], [Experiment 1], [Experiment 2], <Example 1> through <Example 6>, <Comparative example 1> and <Comparative example 2> in the present embodiment 1 are directly applied, thus repetition of explanation is omitted herein.

As described above, according to the present embodiment 5, the fixing apparatus 90 has the fixing roller 91 which is softener feeding means for feeding the fixer 93 containing softener to the transfer paper P which is a recording body, and the pressurizing roller 96 which is the pressurizing means for pressurizing the transfer paper P at the fixing nip which is the softener feeding position to which the fixer 93 is fed. By feeding the fixer while pressurizing the transfer paper with the pressurizing roller 96, fine asperities, which are formed on the surface of a softened toner image on the transfer paper P because of the impacts of the toner particles, are reduced, whereby the smoothness of the surface of the toner image can be improved. Therefore, the smoothness of the surface of a fixed image obtained after hardening and fixing the toner image can also be improved. Accordingly, the fixed image is not scraped off easily even when the fixed image is rubbed, thus the fixed image is prevented from being distorted and thereby the quality thereof can be maintained. Moreover, the speed of penetration of the liquid such as the fixer 93 into the transfer paper P is fast under pressure, thus high-speed responsiveness is possible. It should be noted that when pressure is applied after application of the fixer, hardening of the softened toner image is started therefore, operation of smoothing the surface to improve the smoothness cannot be obtained sufficiently. By applying pressure while applying the fixer, the smoothness can be improved.

Further, as the electric field forming means for generating an electric field in the direction in which the toner is directed toward the transfer paper P side by means of the fixing nip which is the softener feeding position, the fixing roller power source 97 and pressurizing roller power source 98 are connected to the fixing roller 91 and pressurizing roller 96. Accordingly, by applying pressure, the occurrence of offset which may be worsened can be prevented.

The pressure is adjusted so that the linear pressure at the fixing nip between the fixing roller 91 and pressurizing roller 96 can be the pressure at which the entire fixer 93 can pass through the nip, the thickness of the fixer 93 being thinned on the fixing roller 96, whereby the occurrence of a liquid pool is prevented.

On the basis of the conditional equations according to elastohydrodynamic lubrication theory, the pressure is adjusted so that the fixer 93 can pass through the fixing nip, whereby the occurrence of a liquid pool is prevented.

Also, since the fixing roller 91 comprises the fixing roller elastic layer 91c as the elastic layer, an optimum contact state can be created by the elastic layer.

Furthermore, the fixing roller 91 and the pressurizing roller 96 each comprises a conductive cored bar section, and an electrode is connected to the cored bar section to form an electric field, whereby a stable electric field can be formed and the occurrence of offset can be prevented.

Moreover, the resistance value between the cored bar section of the fixing roller 91 and the cored bar section of the pressurizing roller 96 is set to be at least the resistance value of the transfer paper P. Accordingly, even if the length of the transfer paper P is shorter than the width of the fixing roller 91, the fixing electric field for preventing the occurrence of offset can be caused to function effectively on the transfer paper P section.

The engraved roller 92 as a fixer application roller for applying the fixer 93 to the fixing roller 91 is provided, and uniform grooves are formed on the surface of the engraved roller 92. Therefore, uniform amount of fixer 93 can be stably fed to the fixing roller 91, whereby the image quality can be stabilized after the fixing.

Moreover, there is provided the pressurizing roller cleaning blade, which is the pressurizing roller fixer removing means for removing the fixer 93 adhered to the pressurizing roller 96. Accordingly, the fixer 93 can be prevented from flowing from the pressurizing roller 96 side into the fixing nip, and fluctuation of the feed amount of the feed amount of the fixer 93 and the occurrence of a liquid pool at the inlet of the fixing nip can be prevented.

By using a substantially insulating material as the fixer 93 to increase the resistance of the fixer 93, the effect of the electric field for preventing the occurrence of offset can be practiced.

As the diluting solution configuring the fixer 93, the same substance as the carrier solution of the liquid developer is used. Accordingly, the fixer can be prevented from being repelled ian image using the liquid developer, and the fixing speed can be increased.

Furthermore, the fixing apparatus 90 is used as the fixing means of the printer 100 which is the image forming apparatus. Accordingly, the electricity used in the operation of the image forming apparatus can be reduced significantly since heat energy is not required when fixing the toner. Also, the electricity can be reduced at the time of standby since it is not necessary to perform preheating as with the heat roller, and the number of fans for exhausting heat can be reduced, thus the fixing apparatus is advantageous in reducing noise.

It should be noted that, although the present embodiment 5 explains the image forming apparatus with a fixing apparatus on the basis of the printer which is an image forming apparatus of electrophotographic system in which liquid developer is used, the fixing apparatus is not limited to the one using the liquid developer, thus the same effect can be obtained with the same configurations even in the case of a dry-type electrophotograph.

According to the present embodiment, the smoothness of the surface of the softened toner can be improved, whereby the smoothness of the surface of the fixed image is also improved after hardening the image. Therefore, even when rubbing the fixed image, it is not scraped off, thus the fixed image can be prevented from being distorted and the quality of the fixed image can be maintained.

6^{th} Embodiment

Hereinafter, an embodiment 6 is described in detail with reference to the drawings.

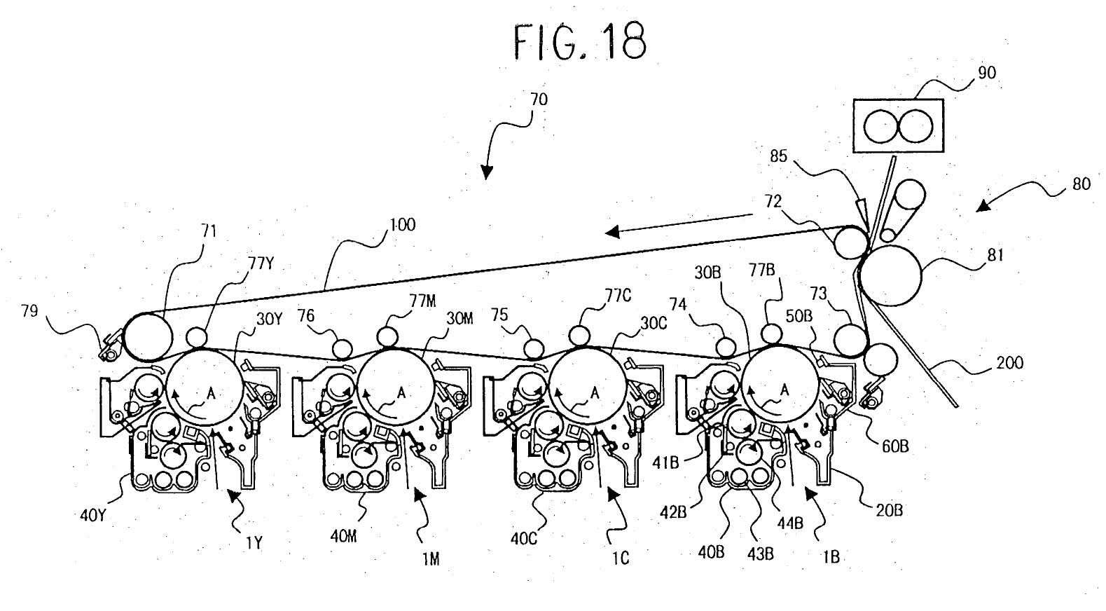

FIG. 18 is a figure showing a schematic configuration of a copying machine which is an image forming apparatus according to the embodiment 6.

In the figure, the reference numeral 1 is an image forming section, 20 is a charger, 30 is a photoconductor, 40 is a development apparatus, 41 is a developing roller, 42 is a cleaning member, 43 is a stirring screw, 44 is an application roller, 50 is an electricity-removing lamp, 60 is a cleaning member, 70 is an intermediate transfer unit, 71, 72 and 73 are suspension rollers, 74, 75 and 76 are tension rollers, 77 is a primary transfer bias roller, 79 is a cleaning member, 80 is a transferring apparatus, 81 is a secondary bias roller, 85 is a separation apparatus, 90 is a fixing apparatus, 100 is a transfer belt, and 200 is a transfer paper as a recording medium. Also, A is an arrow indicating the rotation direction, and B, C, M and Y are colors indicating black, cyan, magenta, and yellow respectively.

The basic concept of the present embodiment 6 is such that when increasing the speed of penetration of the fixer, a fixing step of deforming the toner and increasing the adhesion between toner particles and adhesion between the toner and recording medium is not required to be performed at a step prior to application of the fixer, because such step can be performed by the function of the fixer. Therefore, heating of the toner particles, recording medium, and fixer feeding means can be performed even under a non-contact state with an image surface.

In the figure, the charger 20, the image forming section 1 for forming an image using a light beam from an unshown exposure apparatus, the development apparatus 40, the transfer apparatus 80, and the cleaning apparatus 60 are disposed around the photoconductor 30 which is a latent image supporting body. As the material of the photoconductor 30, a-Si, OPC or the like can be used. As the charger 20, the one in the form of a roller or charger can be used. Also, as the exposure apparatus, an LED, laser scanning optical system or the like can be used.

A case in which an image is formed by means of reversal development using the copying machine having the above configuration is explained.

The photoconductor 30 is driven by an unshown driving means such as a motor to rotate in a direction shown by the arrow A at a constant speed at the time of copying. After the photoconductor 30 is charged uniformly by the charger 20 in the dark, an original light image is irradiated by exposure and thereby an image is formed in the image forming section 1, and an electrostatic latent image is supported on the surface of the outer periphery of the photoconductor 30. Thereafter, the electrostatic latent image is developed while passing through the development apparatus 40. The toner image developed on the electrostatic latent image is transferred to the intermediate transfer belt 100 at the transfer section 77, and thereafter transferred to the transfer paper 200. After the transfer, the photoconductor 30 uses the electricity-removing lamp 50 to eliminate residual potential, and the residual toner is removed by the cleaning apparatus 20 to prepare for the next image formation.

The transferred transfer paper 200 is conveyed to the fixing apparatus 90. First, an electric field which presses toner particles against the recording medium is formed by unshown electric field application means, thereafter fixing solution containing a component for dissolving resin particles of the toner is fed by unshown feeding means, and the toner particles are fixed in a dissolved/swollen manner. At this moment, the binding between the recording medium and the toner particles is enhanced beforehand by the electric field application means, thus flow of toner particles caused by application of the fixer can be prevented, and the image can be prevented from being distorted.

The developer used in the copying machine of the present embodiment 6 is not the liquid developer low viscosity (approximately 1 [mpa·s]) and low density (approximately 1[%]) using Isopar (trademark of Exxon Corporation), which is commercially available and generally used conventionally, as a carrier, but the liquid developer with high viscosity and high density. As the range of the viscosity and the density of the developer, for example, a developer having a viscosity of 50 through 10000 mPa·s and density of 5% through 40% is used. As the carrier solution, the one with high insulating properties such as silicone oil, normal paraffin, Isopar M (trademark of Exxon Corporation), vegetable oil, mineral oil, or the like is used. The volatility or nonvolatility can be selected according to the purpose. The diameter of a toner particle can be selected from submicron through 6 μm according to the purpose.

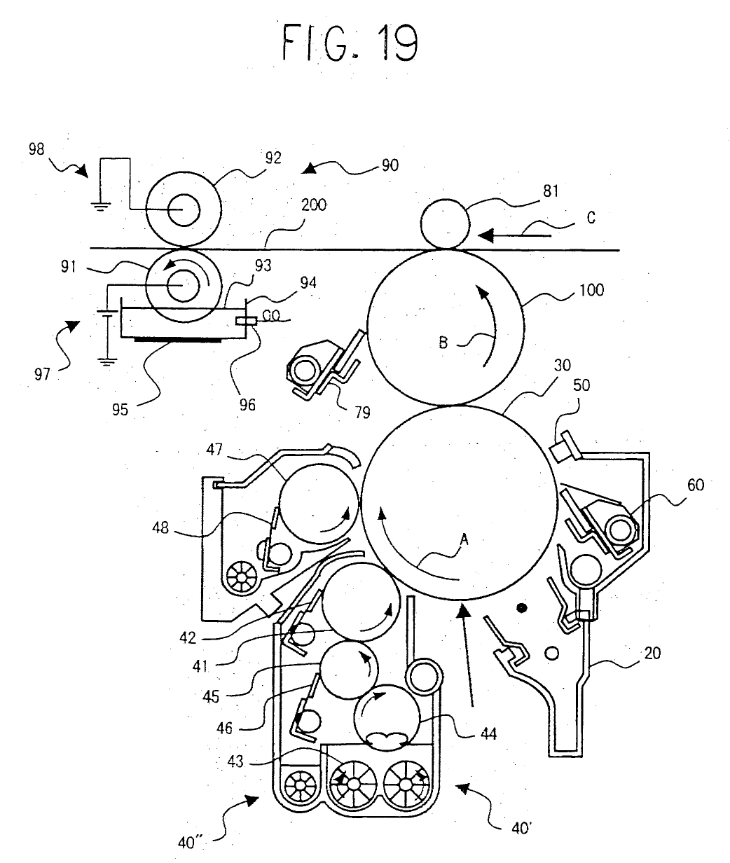

Next, the development apparatus of the present embodiment 6 is described with reference to FIG. 19.

In FIG. 19, the reference numeral 45 is an intermediate roller, 46 is a cleaning member, 47 is a sweep roller, 48 is a cleaning member, 91 is a fixing roller, 92 is a pressurizing roller, 93 is fixer, 94 is a fixer storage tank, 95 is a heater, 96 is a liquid temperature sensor as liquid temperature sensing means, 97 is electric field application means, and 98 is a ground wire. Those members playing the same roles shown in FIG. 18 are applied with the same reference numerals.

FIG. 19 shows the relationship between one image forming station of roller transfer type and a fixing apparatus.

The development apparatus 40 is constituted mainly by, as shown in FIG. 19, a developer storage tank 40′ for storing developer therein, a developing roller 41, sweep roller 47, application roller 44 and intermediate roller 45 which are application means and the surfaces of which are engraved with a uniform pattern, and stirring screw 43. The developing roller 41, intermediate roller 45, and sweep roller 47 are provided with, respectively, cleaning members 42, 46 and 48 which are configured from a metal blade or rubber blade. Each of the cleaning members may not only be in the form of a blade but also in the form of a roller.

An elastic layer having conductivity is provided on the outer periphery of the developing roller 41 and the sweep roller 47. As the material of these elastic layers, aurethane rubber can be used. The hardness of the surfaces of these elastic layers is desirably 50 degrees or less as measured by JIS-A hardness so that a nip can be efficiently formed between the photoconductor and the elastic layers. The material of the elastic layers is not limited to urethane rubber, and thus can be a conductive material which does not swell or dissolve in the carrier solution/developer. If the surfaces of the developing roller 41 and the sweep roller 47 have conductivity and are configured by a material which does not swell or dissolve in the carrier solution/developer, and the carrier solution/developer does not come into contact with inner layer of the developing roller 41 and sweep roller 47, then the material of the elastic layers as the inner layers may not have any restriction in the conductivity/swelling and dissolving, and thus only needs to have elasticity. At this moment, developing bias voltage/sweep bias voltage needs to be applied to from the surfaces of the developing roller 41/sweep roller 47, not from axes of the developing roller 41/sweep roller 47.

Also, the configuration is not limited to the one in which the elastic layer is provided on the developing roller 41 or the sweep roller 47, thus a configuration may be formed in which the elastic layer is provided on the photoconductor 30 side. Moreover, the photoconductor 30 may be constituted by an endless belt-like member. The developing roller 41 and the sweep roller 47 are configured such that the surfaces thereof have a smoothness of at least Rz 5 μm, by means of a coating or a tube.

When the developing roller 41 and the sweep roller 47 are caused to abut against the photoconductor 30 with appropriate pressure, the elastic layers of the rollers elastically deform to form a developing nip and a removal nip respectively. Particularly by forming the developing nip, it is possible to secure fixed developing time for moving the toner inside the developer to the photoconductor by means of the developing electric field of the developing region and adhering the toner. Also, by adjusting the abutment pressure, the nip width, which is the size in the moving direction on the surface in each nip section, can be adjusted. Each nip width is set to be at least the product of the linear speed of each roller and a developing time constant. Here, the developing time constant is time required for the developed amount is saturated, and is obtained by dividing the minimum required nip width by processing speed. For example, if the minimum required nip width is 5 mm and the processing speed is 500 mm/s, the developing time constant is 10 msec.

At the time of developing operation, on the developing roller 41, a thin layer of developer is formed by the application roller 44 by means of the intermediate roller 45. At this moment, the thickness of the developer applied onto the developing roller 41 is set so that the pigment content in the toner which is supported per 1 cm² of the surface of the developing roller 41 becomes at least 3 μg and 60 μg or less. In order to realize this thickness, the fixer is applied so that the thickness of the developer thin layer becomes 3 μm through 12 μm. The reason is that, if the developer thin layer has a thickness that reduces the pigment content in the toner to less than 3 μg, the toner being supported per 1 cm² of the surface of the developing roller, a sufficient amount of the pigment is not moved to a latent image section formed on the photoconductor, whereby the image density on the image section maybe reduced. Moreover, if the developer thin layer has a thickness that increases the pigment content in the toner to more than 60 μg, the toner being supported per 1 cm² of the surface of the developing roller, excess toner remaining on the ground section after development increases, whereby the excess toner may not be removed completely by the sweep roller 47.

Then, the thin layer of the developer which is formed on the surface of the developing roller 41 is developed in response to a latent image on the photoconductor 30 when the developing nip formed by the photoconductor 30 and developing roller 41 is passed through. Specifically, at the image section, the toner moves to the photoconductor 30, and, at the ground section (non-image section), the electric field formed by developing bias potential and photoconductor potential moves the toner to the surface of the developing roller 41 to prevent the toner from adhering to the ground section. However, when a part of the toner at the ground section is not completely moved to the surface of the developing roller 41 and remains on the photoconductor 30, a fogging occurs. Therefore, the development apparatus of the copying machine according to the present embodiment 6 is provided with the sweep roller 47 for sweeping (removing) the toner which is the cause of the fogging (referred to as “fog toner” hereinafter). This sweep roller 47 is disposed on the downstream side in the rotational direction of the photoconductor 30 with respect to the developing roller 41 so as to have the developed toner image between the sweep roller 47 and the developing roller 41, the sweep roller 47 being pressed against the photoconductor 30. The sweep roller 47 removes the fog toner formed on the ground section, while moving the surface thereof at substantially the same speed as the photoconductor 30 moving the surface thereof.

After development is performed by the developing roller 41, the toner is recovered by the cleaning member 42 in order to prevent ghost to occur, and then removed by a cleaning member 48. These liquid developers are collected into an adjusting tank 40″ in which the density of the developer is adjusted, and thereafter the developers are sent into the development apparatus 40 again. The adjusting tank 40″ has stirring means, unshown density detecting means, and unshown liquid amount detecting means, wherein the density and the liquid amount are detected in a state in which the density in the tank is made uniform, and then the density is adjusted by replenishing new liquid developer and carrier. From that moment, the amount of the liquid developer fed into the development apparatus 40 is set so as to be slightly larger than the used amount of the liquid developer, and the spilled amount of the liquid developer is brought back to the adjusting tank 40″, whereby the liquid developer constantly circulates.

Next, as the characteristics of the present embodiment 6, a fixing step using the fixer is described.

The fixing apparatus 90 comprises the fixing roller 91 which is feeding means of the fixer 93, and the pressurizing roller 92 facing the fixing roller 91 and holding the recording medium 200 therebetween. A part of the fixing roller 91 is immersed in the fixer 93, and thereafter a metering blade lined with a metallic plate is used to scrape of excess liquid, whereby the fixer 93 is held on the surface of the fixing roller 91 at an amount required for the fixing. On the other hand, the pressurizing roller 92 is in contact with the fixing roller 91 so that the recording medium 200 having an unfixed image thereon is conveyed therebetween. Since the fixer 93 is fed to the pressurized nip, the softened resin is crushed so that the smoothness of the surface is improved, and the quality of the fixed image is also improved. The heater 95 is described hereinafter.

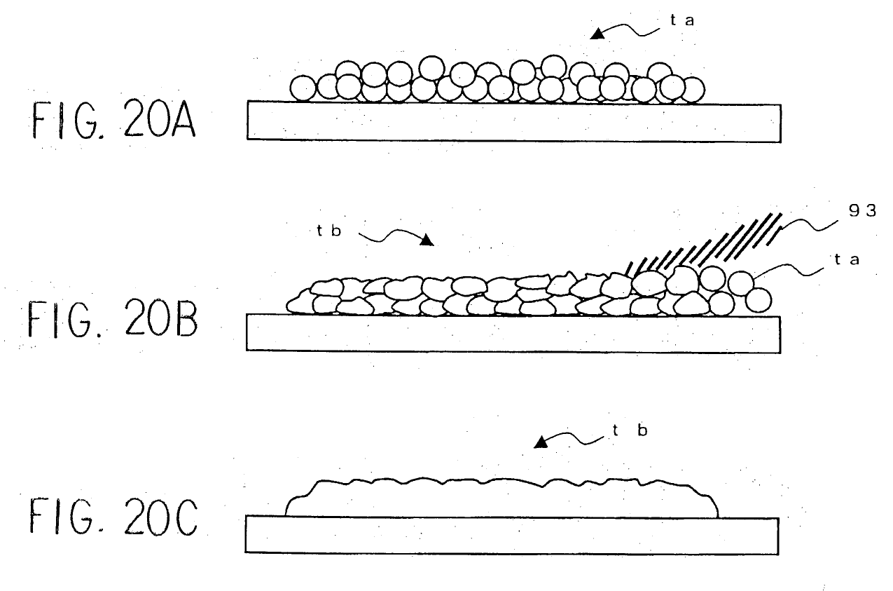

FIGS. 20A through 20C show a fixing step for fixing toner resin formed on the recording medium. In the figures, the reference numeral ta is an unfixed toner, and tb is a fixed toner.

In FIG. 20B, when applying the fixer to a resin of the unfixed toner ta, the rein is dissolved/swollen in the fixer and thereby generates viscosity. The fixer is then ejected from the resin by the effect of the pressure of the rollers and penetrates the recording medium or the like, whereby the resins are bonded with each other to form a fixed state tb.

When an excess amount of the softener is fed, binding of the softened resins does not occur easily, thus the viscosity still remains in the softener for a period of time even after the fixer is fed. Therefore, the speed of diffusion/penetration in which a bonding step is considered to be caused by diffusing the fixer into the resin or penetrating the fixer into the recording medium is very important for the high-speed responsiveness.

Incidentally, the pressure at the fixing nip to which the fixer is fed is required to be sufficient for deforming the softened resin. For example, the pressure is preferably approximately several tens through several hundreds [kpa]. The smoothness of the surface of the fixing roller is preferably good, because the impacts on the surface can be considered to occur at the time of pressurization. For example, the surface roughness is preferably 2 to 3 [μm] or less in the ten point height of roughness profile Rz.

The fixer application apparatus used in the present embodiment 6 comprises the electric field application means 97 at the feed section for feeding the fixer 43, wherein there is generated an electric field that presses toner particles against the recording medium 200, the toner particles having positive or negative polarity when the electric field is fed. By this electric field, it is possible to prevent the occurrence of offset in which the toner is transferred to the fixing roller 41. The offset state changes according to the voltage to be applied. In the fixer application apparatus of the present embodiment 6, a voltage of at least 600 V was applied to form the electric field, whereby the offset can be prevented from occurring.

The present embodiment 6 is a so-called new solvent fixing system using a fixer containing a softener, wherein, in the conventional technologies, problems regarding odor, safety, high-speed follow-up and the like were pointed out, and it was considered that there may be a limit in high-speed copying. However, as described above, by using an application roller system to apply the softener and thereby forming a thin layer, high-speed fixing can be performed, and further by heating the fixer or increasing the temperature of the fixer, the fixing speed further increases. Of course, the problems regarding the safety and odor of the softener, and toner offset on the roller of the application roller system were all cleared.

Incidentally, the reason that the high-speed follow-up was possible by heating the fixer or increasing the temperature of the fixer is because, as described above, the fixer with the softener, which was fed to the toner layer, softened the resin at the bonding step and was dispersed in the resin or impregnated in the recording medium, whereby the toner on the surface layer was further hardened. Also, it is considered that because of the speed of dispersion/penetration, the fixer was heated or the temperature of the fixer was increased, whereby the fixer was further immersed and dispersed into the toner resin.

Again, in order to increase the speed of dispersion/penetration of the fixer into the toner layer and recording medium, as the means for improving the permeability of the fixer, there are methods of:
reducing the viscosity of the fixer; and
improving the affinity of the fixer for the carrier solution contained in the toner layer.

In order to achieve these methods, there are methods of increasing the temperature of the fixer or heating the fixer, and heating the recording medium itself or increasing the temperature of the recording medium itself. In the latter case, a case in which the toner layer is not supported on the recording medium is considered. In other words, two cases, i.e. a case in which the temperature is increased or heat is applied before transfer, and a case in which the temperature is increased or heat is applied after transfer, are considered.

Next, the components of the fixer are explained.

1. Softener

The softener used in the present embodiment 6 is a material for dissolving or swelling the resin component configuring the toner (referred to as “softener” hereinafter) Desirably this softener does not vaporize, is odorless, and does not have affinity for water. As a specific example of this dissolving/swelling component, there are saturated aliphaticester, aliphatic dicarboxylicacidester, aliphatic dicarboxylic acid dialkoxy alkyl and the like.

The saturated aliphatic ester is a compound expressed by a general formula, “R₁COOR₂”, wherein, R₁ is an alkyl group having 11 to 14 carbon atoms, and R₂ is an alkyl group having 1 to 3 carbon atoms. Examples of aliphatic monocarboxylic ester include ethyl laurate, ethyl tridecylate, isopropyl tridecylate, ethyl myristate, isopropyl mysristate, and the like. These compounds hardly vaporize, and dissolves in silicone oil, PAO, or other synthetic oil and mineral oil, and hydrocarbon solvent. These compounds are insoluble and the solubility thereof in water is not more than 0.1 g/100 ml (25° C.).

The aliphatic dicarboxylic acid ester is a compound expressed by a general formula, “R₃ (COOR₄) ₂”, wherein, R₃ is an alkylene group having 3 to 8 carbon atoms, and R₄ is an alkyl group having 2 to 5 carbon atoms. Examples of the aliphatic dicarboxylic acid ester include dibutyl sebacate, di-isobutyl adipate, diisopropyl adipate, diethyl sebacate, dibutyl sebacate, and the like. Most of these components hardly vaporize, and are dissolved in silicone oil, PAO, or other synthetic oil and mineral oil, and hydrocarbon solvent. These components are insoluble and the solubility thereof in water is at least 0.1 g/100 ml (25° C.).

Aliphatic dicarboxylic acid dialkoxy alkyl is a compound expressed by a general formula, “R₅ (COOR₆-O—R₇)₂”, wherein, R₅ is an alkylene group having 2 to 8 carbon atoms, R₆ is an alkylene group having 2 to 4 carbon atoms, and R₇ is an alkyl group having 1 to 4 carbon atoms. Examples of the aliphatic dicarboxylic acid dialkoxy alkyl include diethoxyethyl succinate, dibutokxyethyl succinate, diethoxyethyl adipate, dibutokxyethyl adipate, diethoxyethyl sebacate, and the like. Most of these components hardly vaporize. These components are insoluble and the solubility thereof in water is at least 0.1 g/100 ml (25° C.). The solubility of these components in synthetic oil such as silicone oil and PAO, mineral oil, or hydrocarbon solvent is relatively low, thus there is a method of emulsifying and dispersing the components in synthetic oil such as silicone oil and PAO (poly a olefin), mineral oil, or hydrocarbon solvent by means of a surfactant having an HLB value of approximately 1 through 5.

In any of the above-described saturated aliphatic esters, the larger the number of carbon atoms, the higher the viscosity and nonvolatility. Moreover, the odor of these saturated aliphatic esters can be reduced by refining, and the esters with a high degree of purity are nearly odorless.

The examples of the liquid softener are as described above. By using a liquid softener as the softener, the softener quickly penetrates the toner layer, compared to the case where the softener is a solid or gel softener. Even in the case of a liquid softener, the degree of penetration thereof depends on the viscosity or surface energy, thus the lower the viscosity the higher the speed of penetration. If the fixer is liquid, it can be fed easily by using a pipe or pump. Also, the method of feeding the softener is simple because the liquid fixer does not scatter like powder and is very useful.

Furthermore, other advantages are that it is easy to restrict the quantity of the softener to be fed because a thin film can be formed easily, and, compared to powder, the softener can be mixed into the resin particles.

2. Diluting Solution of the Softener

When the required amount or more of the dissolving/swelling component is fed to a resin to fix the toner thereon, the resin is dissolved excessively and thereby a flow of resin to be fixed occurs. The resin for fixing the toner thereon is desirably in a semi-dissolved state or swollen state. Depending on the types of the dissolving/swelling components, it is sufficient that the amount of the dissolving/swelling component is generally less than half the amount of the resin. If at least half or more of the resin is not fed, the dissolving/swelling component which is not dissolved and swollen is not suitable for a treatment of a dissolving/swelling component obtained after dissolving and swelling the resin. For example, the amount of toner for configuring a toner image on the transfer paper is desirably a few μm levels in thickness, and the dissolving/swelling component is desirably fed thinner in thickness and smaller at an amount than the toner. Although it is desired that the dissolving/swelling component be fed thinner in thickness and smaller at an amount, it is extremely difficult to uniformly feed a small amount of softener which is the dissolving/swelling component. Therefore, as a method of feeding such a small amount of dissolving/swelling component, generally, there is used a method of diluting the dissolving/swelling component by using some sort of liquid.

As the diluting solution, there is known the one using water in consideration of an impact on the environment. However, when using water, or a dispersing solution/diluting solution having a good affinity for water when mixed with water and also having good solubility easily, the water vaporizes easily and the moisture is easily absorbed, the density of the diluted fixer changes easily. Other problem is the keeping quality of the agent for dealing with decay and the like. Further, if using whereby the moisture in the air is absorbed and the thereby the density changes easily. Furthermore, the dispersing solution or diluting solution may not be applied evenly because of the surface energy of the photoconductor, intermediate transfer body, or film-like recording body. When using a transfer paper, there may arise a problem that the paper is cockled (wrinkled). Moreover, if vaporizing, the odor may generated, causing air pollution.

In order to resolve these problems, it is desired to employ dispersing solution/diluting solution which is nonvolatile, insoluble in water and nearly odorless. Examples thereof include silicone oil, mineral oil, and the like. Both silicone oil and mineral oil has various structures and grades (viscosity/molecular weight). In the present embodiment, solution, which is obtained by mixing 50% of the abovementioned softener with equal to or less than 50% of silicone oil 50 cst as the diluting solution, is used as the fixer.

If the softener is liquid, only the softener can be used as the fixer. However, the amount of resin on the recording medium is extremely small, thus it is difficult to feed the amount of softener which is smaller than that of the resin. Therefore, by diluting the softener using an appropriate amount of diluting solution and feeding the obtained solution as the fixer 93, a required amount of softener is contained in the fixer the amount of which can be stably fed.

3. Temperature Dependency of Fixing Time

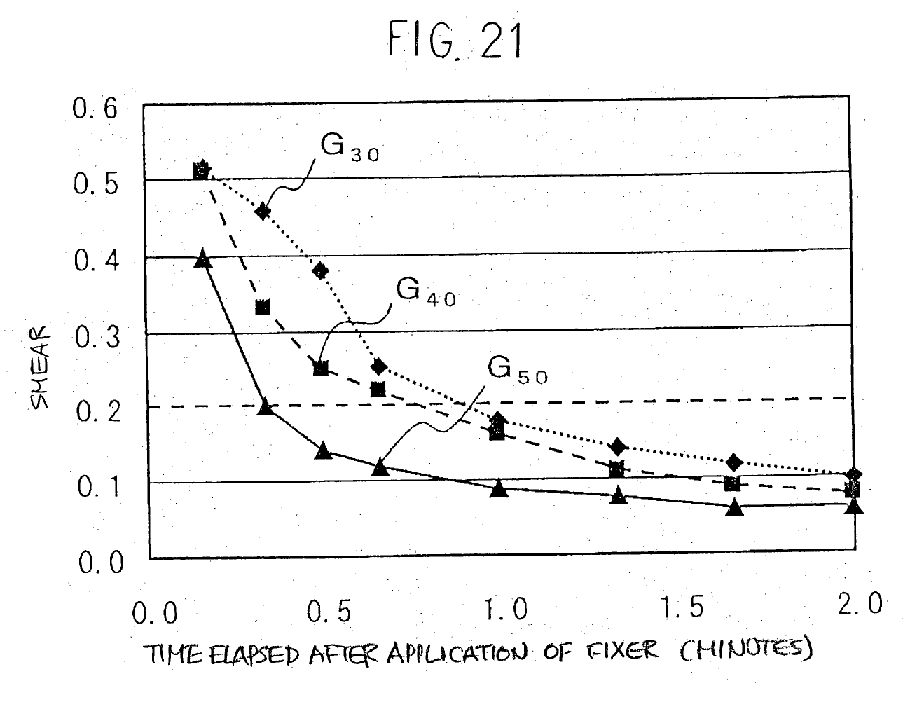

FIG. 21 is a figure for explaining fixing temperature dependency of the fixing time and smear.

In the figure, the reference numerals G₃₀, G₄₀, and G₅₀ are curved lines indicating the changes in smear at liquid temperatures of 30° C., 40° C., and 50° C. respectively at the time of fixing. The horizontal axis show the time elapse since application of the fixer (unit: minute(s)), and the vertical axis shows smear values described hereinafter.

The fixing time is time until which satisfactory fixing properties are obtained after feeding the fixer. Satisfactory fixing properties indicate the state in which the smear value is 0.2 (broken lines in the figure) or less.

The present embodiment 6 is a solvent fixing system in which the fixer containing a softener is fed to an unfixed image (toner) on a recording medium, the toner image is softened and partially dissolved, and then fixed onto the recording medium (transfer paper). The fixing speed depends on the speed of penetration of the fixer into resin particles or the recording medium, and the time required for softening the resin. In order to reduce the fixing time, it is important to increase the speed of penetration of the fixer into the toner layer. The viscosity of the fixer has large impacts, thus the lower the viscosity, the higher the penetration speed. Moreover, the time required for softening the resin is changed by temperature, thus the higher the temperature, the shorter the time.

The smear value described herein means a value obtained in the following detection procedure.

An elastic material having a thickness of 5 mm is provided as a cushion material on an end of a clockmeter, and this end is covered with a cloth. The density on the cloth (three points average) was measured after rubbing on a solid image 10 laps back and forth (Dcrk), and the value obtained by subtracting the cloth density (Dcls) from the measured amount is divided by original image density (Dinit). Thus obtained value Dsmr is taken as an evaluated value in the smear method. Specifically, Dsmr is obtained by the following equation.
Dsmr=(Dcrk−Dcls)/Dinit Eq. (8)

The smaller the value of Dsmr, the better the fixing properties, thus the current target value is 0.2 or less.

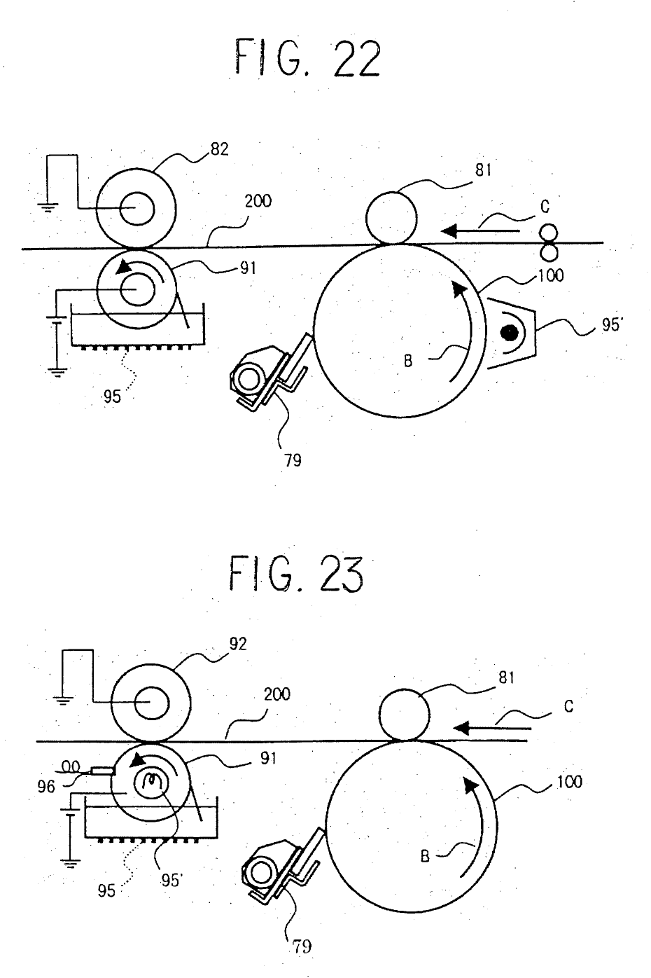

FIG. 22 is a figure for explaining a modification of the embodiment 6.

In the present modification, it is considered that the resin is softened to increase the speed of penetration of the fixer, whereby the speed of softening the resin by means of the fixer is increased. In the image creating apparatus using the intermediate transfer body 100, the heater 95 for increasing the temperature of liquid, means for heating the toner particles (resin) transferred onto the intermediate transfer body 100, and, for example, an infrared heater 95′ are provided. The infrared heater 95′ softens the toner particles. The toner particles are transferred onto the transfer paper 200 and are further softened by the fixer 93 when the fixer 93 is fed, whereby the fixing time period becomes shorter. The toner particles softened by the heater are softened by the fixer faster than the toner particles which are not softened by the heater. It should be noted that the heater 95 for increasing the temperature of liquid can be omitted if a sufficient effect can be obtained with the infrared heater 95′ only.

At this moment, it is more advantages that the amount heat applied to the resin be high. It is because the fixing time period can be shortened particularly, a drastic effect can be obtained if the temperature of the resin is at least the glass transition point. However, such application of heat is not for fusing the toner as with a conventional heat fixing system, thus the amount of heat used in the heat fixing system is not required. Particularly the amount of heat does not have to exceed the fusing point. Such application of heat has an effect of softening the resin to increase the speed of penetration of the fixer, keeping the fixing temperature at an effective level for softening the resin by means of the fixer, and prevent the fixer temperature from being reduced when the fixer temperature is increased.

The heater 95 shown in FIG. 19 functions as means for reducing the viscosity of the fixer to reduce the fixing time period and is disposed for the purpose of heating the fixer 93. In order to adjust the fixer temperature, liquid temperature detecting means 96 is provided in a fixer container to detect liquid temperature, and the heater 95 is turned ON/OFF on the basis of the detected liquid temperature. It should be noted that this method can be also used for the purpose of heating the fixer even when using this method in cold climates, and controlling the fixer temperature at a constant level in order to constantly provide steady fixing quality.

29 When the relationship between the liquid temperature and fixing properties (smear) in this modification, excellent fixing properties were obtained in a short period of time when the liquid temperature was 50° C. rather than 30° C.

A large merit in fixing solvent is that the fixing is performed in a non-heating fashion. When heating the fixer, the heat source (heater) is controlled by setting the electricity and temperature to upper limits such that the electricity is ½ through ⅓ (200 through 300 W or less) of the conventionally used electricity, and specific temperature is 100° C. or lower or preferably approximately 50° C.

FIG. 23 is a figure for explaining other modification of the present embodiment 6.

If the heat capacity of the feeding means is large, only heating the fixer 93 reduces the fixer temperature, whereby a sufficient effect is not obtained and a long fixing time period is required. Therefore, the heating means 95′ is provided on the fixer feeding means as well, and the temperature is set so as to be the same as the temperature of the fixer 93, whereby a sufficient effect is obtained. The figure shows an example in which, as the fixer feeding means, the fixing roller 91 having a heater incorporated therein is used. If the heat capacity of the feeding means is larger than the heat capacity of the fixer, the temperature of the fixer can be controlled only by controlling the temperature of the feeding means.

Although not shown, the heater may be embedded in the pressurizing roller 92, and this configuration may be used as a heat roller.

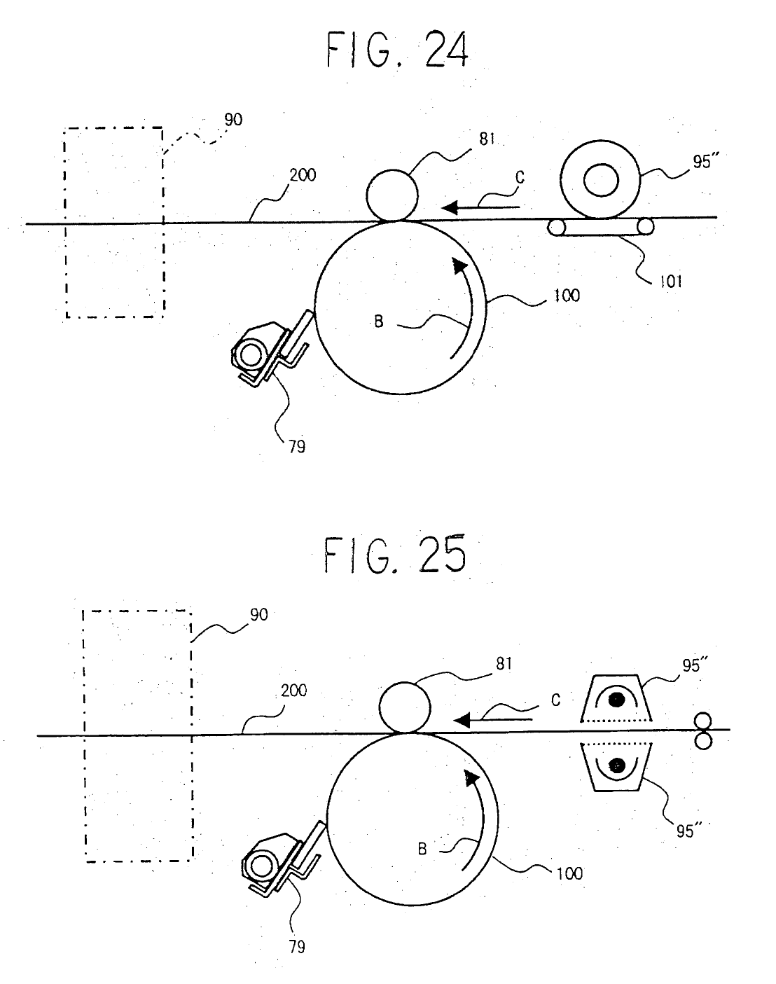

FIG. 24 is a figure for explaining other modification of the present embodiment 6. In the figure, the reference numeral 101 indicates a conveying belt for conveying the recording medium. FIG. 25 is a figure for explaining a further modification of the present embodiment 6.

Even if the fixer 93 or fixer feeding means 91 is heated, if the recording medium 200 with a low temperature comes in, the fixer temperature or color resin temperature is reduced, whereby a sufficient effect may not be obtained. Therefore, by increasing the temperature of the recording medium as well, a better effect is obtained.

When considering the reduction of the fixing time period, increase of the speed of penetration of the fixer into the toner layer, reduction of the viscosity of the color resin, and increasing the fusing properties are considered. The effect obtained by heating the fixer or increasing the fixer temperature using the means of reducing the viscosity of the fixer are as described above. On the other hand, by heating the recording medium (transfer paper), the same effect can be obtained. Moreover, by heating the recording medium, an effect of heating the color particles on the recording medium is also obtained, whereby the fixing time period can be shortened.

The embodiments shown in the both figures are examples of heating the transfer paper before transfer, and various heating means can be installed for applying head in a contact manner (FIG. 24), non-contact manner (FIG. 25), from the surface of the image (FIG. 24, FIG. 25), from the back of the image (FIG. 25) and the like.

In the embodiments shown in FIG. 24 and FIG. 25, the heating means of the fixing apparatus 90 (heater 95 or infrared heater 95′) may be added according to need, thus a specific configuration thereof is not illustrated in either figure. The same is true for the following figures. However, by combining the heater with the fixing apparatus well, used energy can be reduced and high fixing effects can be obtained.

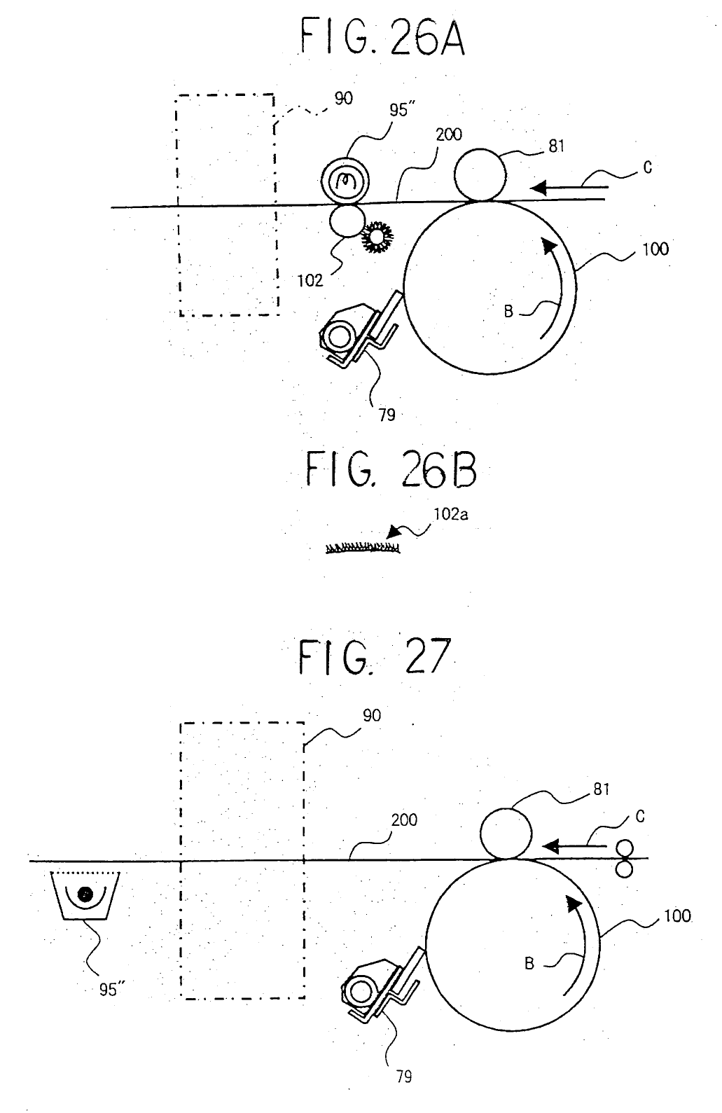

FIG. 26 is a figure for explaining a further modification of the present embodiment 6. In the figure, the reference numeral 102 is an emery roller functioning as the pressurizing roller.

Although it is effective to heat the transfer paper prior to application of the fixer, it is more preferred to heat the recording medium 200 on which color particles (toner particles) are placed, in order to enhance the effects. When heating the toner particles and the recording medium 200, in order to heat them without allowing them to directly contact with an unfixed toner, a heat roller 95″ having incorporated a heater therein and the emery roller 102 are driven such that the heat roller 95″ is caused to abut against the surface opposite of the toner image surface and the emery roller 102 is caused to abut on the image surface, whereby the image is prevented from sliding. The emery roller uses its peak to locally hold the image surface in point-contact manner, and presses the recording medium 200 against the heat roller side so as not to touch the image or not to distort the image as much as possible even when toughing the image.

FIG. 27 is a figure for explaining a further modification of the present embodiment 6.

When heating the transfer paper 200 and toner image after applying the fixer 93 to the toner image, excellent fixing was performed in a short period of time. Even when heating the fixer 93 or fixer feeding means 91, after the fixer is fed the temperature of the transfer paper 200 is reduced according to the environment, and particularly the effect of increasing the speed of the fixer 93 penetrating the transfer paper 200 in the penetration step may be deteriorated. Therefore, by heating the recording medium 200 after feeding the fixer, high temperature can be kept for a long period of time, the color resin, fixer 93, fixer feeding means 91, recording medium 200 and the like can be heated, and fixing can be performed more promptly.

As a method of heating performed after applying the fixer, there is a method of causing an infrared non-contact type heater or the opposite surface, which does not have a toner image, to abut against the transfer paper and heating the heater or the opposite surface.

The recording medium is specifically a transfer paper, and there are various types of recording media. According to our examination, the quality of a transfer paper has an impact on the fixing quality (fixing in a short period of time). If the transfer paper is thick, the heat capacity is large, thus the fixer temperature is reduced when applied and the fixing speed is also reduced under the same fixer temperature or the same temperature of the fixer feeding means. Therefore, by increasing the temperature of the fixer or the fixer feeding means in accordance with the thickness of the transfer paper, the speed of the fixer penetrating the transfer paper promptly can be made the same as with the case in which the transfer paper is thin. Moreover, when the smoothness is low, heat transfer is not good, thus the temperature of resin cannot be increased if the temperature of the fixer or fixer feeding means is not increased. Therefore, by adjusting the temperature of the fixer or fixer feeding means in accordance with the smoothness, it is possible to obtain the fixing properties that are the same as those when a paper with high smoothness is used. Moreover, regarding a coat paper, in the case of a coat layer into which the liquid cannot penetrate easily, the temperature of the fixer or fixer feeding means may be increased in order to prevent the penetration from being interrupted. In this manner, the speed of penetration and dispersion of the fixer varies according to the physical properties (thickness, smoothness, and the like) of the transfer paper. Therefore, by changing the temperature of the fixer or the temperature of the fixer feeding means in accordance with the physical properties of a paper, fixing can be performed efficiently without changing the fixing speed in accordance with the type of paper.

Examples of the fixer used in the present embodiment 6 are shown below.
Diisobutyl adipate (softener, LD50=12.3 g/kg)
   50 wt/%
Dimethylsiloxane (50 mpa·s, diluting solution, LD50=15 g/kg)
   50 wt/%

On the basis of an unfixed image formed on a transfer paper of Raicho daruato (product name) having a size of 127 g/m², the copying apparatus shown in FIG. 18 was used to determine a smear value by applying the fixer to the paper at an amount of 80 through 110 mg/A4 at a fixer temperature of 30° C., the smear value obtained 30 seconds after application was 0.38 and the result of evaluation within one minute was 0.18. When the smear value was measure by applying the fixer to the paper at an amount of 80 through 110 mg/A4 at a fixer temperature of 50° C., the smear value obtained 30 seconds after application was 0.14, and the smear value obtained within one minute after application was 0.09. As a result, excellent fixing properties were obtained. FIG. 21 shows a pot of these evaluation results.

Suppose that the smear value obtained in one minute after application is permitted up to 0.2, the fixing properties are all satisfied at a temperature of at least 30° C. In the case of determining the fixing properties at a smear value of 0.2 or less, the smear value being obtained 30 seconds after application, satisfactory fixing properties are obtained at a temperature of approximately 45° C. or above which needs to be inserted into the graph.

As described above, according to the present embodiment 6, in the image forming apparatus comprising a fixing apparatus for applying a fixer to color particles containing a resin, the softener containing a softener for softening the resin, at least one temperature adjusting means is provided so as to obtain temperature which is suitable in fixing, thus the softening of the resin is promoted and the fixing can be performed at high speed.

A plurality of temperature adjusting means are provided, according to need, in various places such as the intermediate transfer body, recording medium before transferred, recording medium after transferred, fixer itself, fixer feed roller, pressurizing roller, recording medium after discharged from the fixing apparatus. Therefore, effects of fixing at high speed can be enhanced.

The temperature adjusting means is used as the heating means using radiation heat and the heating means using a heat roller, in accordance with the installation locations, thus high-speed fixing can be performed more effectively.

Various modifications will become possible for those skilled in the art after receiving the teachings of the present disclosure without departing from the scope thereof.

What is claimed is:

1. A fixing apparatus, which causes a softener having properties of softening resin particles for forming a toner to adhere to the resin particles, and fixes, onto a recording body, a toner image which is formed using a liquid developer comprising the toner and a carrier solution, wherein
the softener has an affinity for the carrier solution.

2. The fixing apparatus according to claim 1, wherein the softener is nonvolatile.

3. The fixing apparatus according to claim 1, wherein the softener is substantially odorless.

4. The fixing apparatus according to claim 1, wherein
the softener is mixed with a diluting agent for diluting the softener or a dispersing agent for dispersing the softener to obtain a fixer, and in such a state the softener is caused to adhere to the resin particles of the toner image and then fed.

5. The fixing apparatus according to claim 4, wherein the diluting agent or the dispersing agent has an affinity for the carrier solution.

6. The fixing apparatus according to claim 4, wherein the diluting agent or the dispersing agent is nonvolatile.

7. The fixing apparatus according to claim 4, wherein the diluting agent or the dispersing agent is substantially odorless.

8. The fixing apparatus according to claim 4, wherein the diluting agent or the dispersing agent is same as the carrier solution.

9. The fixing apparatus according to claim 4, wherein the diluting agent or the dispersing agent is either silicone oil or mineral oil.

10. The fixing apparatus according to claim 4, wherein the softener is fed to the recording body before the toner image is transferred.

11. A fixing apparatus, which feeds a softener having properties of softening resin particles for forming a toner, to a toner image formed on a recording body, and fixes the toner image onto the recording body, the fixing apparatus comprising:
softener feeding means for feeding the softener to the recording body;
pressurizing means for pressurizing the recording body at a softener feeding position to which the softener is fed; and
electric field forming means for forming an electric field in a direction of guiding the toner toward the recording body side at the softener feeding position.

12. The fixing apparatus according to claim 11, wherein the softener feeding means is a fixer feed roller, which forms a thin layer of liquid fixer containing the softener at a predetermined amount of the liquid fixer, supports the fixer on the surface of the softener supplying means, and comes into contact with the toner image formed on the recording boy to feed the softener, and
the pressurizing means is a pressurizing roller which faces the fixer feed roller and holds the recording body therebetween.

13. The fixing apparatus according to claim 12, wherein linear pressure between the fixer feed roller and the pressurizing roller is linear pressure at which the entire fixer formed into a thin layer on the fixer feed roller can pass through.

14. The fixing apparatus according to claim 12, wherein the linear pressure W [N/m] between the fixer feed roller and the pressurizing roller satisfies conditions of the following equation (1),
W<200×[(η³U³R³)/E²h_{f}⁵] Eq. (5)
where
W [N/m]: linear pressure
η [Pa·s]: viscosity
U [m/s]: roller linear speed
R [m]: relative curvature radius
E [N/m²]: equivalent modulus of longitudinal elasticity
h_{f} [m]: fixer thickness (on the fixer feed roller),
the relative curvature radius R [m] is obtained by the following equation (2),
where
1/R=1/R_{f}+1/Rₚ Eq. (2)
R_{f} [m]: radius of the fixer feed roller
Rₚ [m]: radius of the pressurizing roller,
and the equivalent modulus of longitudinal elasticity E [N/m²] is obtained by the following equation (3),
where
1/E=1/2×[(1−δ_{f}²)/E_{f}+(1−δₚ²)/Eₚ] Eq. (3)
δ_{f}: Poisson ratio of the fixer feed roller
δₚ: Poisson ratio of the pressurizing roller
E_{f} [N/m²]: modulus of longitudinal elasticity of the fixer feed roller
Eₚ [N/m²]: modulus of longitudinal elasticity of the pressurizing roller.

15. The fixing apparatus according to claim 12, further comprising pressurizing roller fixer removing means for removing the fixer adhered to the pressurizing roller.

16. An image forming apparatus, comprising:
image forming means for forming an unfixed image by color particles microparticulated through dispersing a color agent and resin;
transfer means for transferring the formed unfixed image onto a recording medium;
feeding means for feeding a fixer, which contains, as a component, a softener having properties of softening the color particles, to the recording medium supporting the unfixed image;
a fixing apparatus which fixes the color particles to the recording medium; and
at least one temperature adjusting means for performing adjustment to obtain temperature suitable for fixing the color particles.

17. The image forming apparatus according to claim 16, further comprising:
an intermediate transfer body which intermediately transfers the formed unfixed image to a space between the image forming means for forming the unfixed image, and the transfer means for transferring the formed unfixed image onto the recording medium,
wherein the temperature adjusting means adjusts the temperature of the unfixed image transferred onto the intermediate transfer body.

18. The image forming apparatus according to claim 16, wherein the temperature adjusting means adjusts the temperature of the recording medium before the unfixed image is transferred.

19. The image forming apparatus according to claim 16, wherein the temperature adjusting means adjusts the temperature of feeding means for feeding the fixer.

20. The image forming apparatus according to claim 16, wherein the temperature adjusting means adjusts the temperature of the fixer.
